(19) United States
(12) Patent Application Publication
(10) Pub. No.: US 2025/0365540 A1
(43) Pub. Date: Nov. 27, 2025

(54) ELECTRONIC DEVICE FOR CONTROLLING PLURALITY OF SPEAKERS ON BASIS OF AT LEAST ONE OF POSTURE AND DIRECTION, AND METHOD THEREFOR

(71) Applicant: Samsung Electronics Co., Ltd., Suwon-si (KR)

(72) Inventors: Hyerim BAE, Suwon-si (KR); Changi PARK, Suwon-si (KR); Jihea PARK, Suwon-si (KR); Sunwoong HAM, Suwon-si (KR); Byounguk YOON, Suwon-si (KR); Changryong HEO, Suwon-si (KR); Hyunchul HONG, Suwon-si (KR); Nahye KIM, Suwon-si (KR); Junyoung CHOI, Suwon-si (KR)

(21) Appl. No.: 19/295,018

(22) Filed: Aug. 8, 2025

Related U.S. Application Data
(63) Continuation of application No. PCT/KR2024/004001, filed on Mar. 28, 2024.

(30) Foreign Application Priority Data
May 22, 2023 (KR) 10-2023-0065390
Jun. 12, 2023 (KR) 10-2023-0075114

(51) Int. Cl. H04R 5/04; G06F 1/16; G06F 3/16; H04R 1/02; H04R 3/12; H04R 5/02; H04S 1/00; H04S 7/00

(52) U.S. Cl. CPC H04R 5/04; G06F 1/1616; G06F 3/165; H04R 1/028; H04R 3/12; H04R 5/02; H04S 1/007; H04S 7/30; H04R 2499/15; H04S 2400/13

(57) ABSTRACT

An electronic device is provided. The electronic device includes a first housing, a first speaker positioned at the first housing, a second housing, a first hinge assembly for rotatably connecting the first housing and the second housing, a third housing, a second speaker positioned at the third housing, a second hinge assembly for rotatably connecting the second housing and the third housing, a flexible display disposed from the first housing to the third housing crossing the first hinge assembly, the second housing and the second hinge assembly, one or more sensors memory comprising one or more storage media storing instructions, and at least one processor including processing circuitry wherein the instructions, when executed by the at least one processor individually or collectively, cause the electronic device to in a state displaying a video in the flexible display, identify, by using the one or more sensors, a first angle by which the first housing and the second housing are folded based on the first hinge assembly and a second angle by which the second housing and a third housing are folded based on the second hinge assembly, and based on at least one of the identified first angle and the second angle, control the first speaker to output a first audio channel corresponding to the first speaker and control the second speaker to output a second audio channel corresponding to the second speaker.

### CROSS-REFERENCE TO RELATED APPLICATION(S)

This application is a continuation application, claiming priority under 35 U.S.C. § 365 (c), of an International application No. PCT/KR2024/004001 filed on Mar. 28, 2024, which is based on and claims the benefit of a Korean patent application number 10-2023-0065390, filed on May 22, 2023, in the Korean Intellectual Property Office, and of a Korean patent application number 10-2023-0075114, filed on Jun. 12, 2023, in the Korean Intellectual Property Office, the disclosure of each of which is incorporated by reference herein in its entirety.

### BACKGROUND

### 1. Field

The disclosure relates to an electronic device for controlling a plurality of speakers based on at least one of a posture or a direction, and a method thereof.

### 2. Description of Related Art

A shape and/or a size of an electronic device are diversifying. To enhance mobility, the electronic device with a reduced size and/or a reduced volume are being designed. The electronic device may include a display for visualizing information. As the number of functions supported by the electronic device is increased, a size of the display may be increased to visualize more information to a user and/or to support execution of the functions. For example, the size of the display may be designed to be maintained or increased while the size and/or the volume of the electronic device are reduced.

The above information is presented as background information only to assist with an understanding of the disclosure. No determination has been made, and no assertion is made. as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for controlling a plurality of speakers based on at least one of a posture or a direction, and a method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a first housing, a first speaker positioned at the first housing, a second housing, a first hinge assembly for rotatably connecting the first housing and the second housing, a third housing, a second speaker positioned at the third housing, a second hinge assembly for rotatably connecting the second housing and the third housing, a flexible display disposed from the first housing to the third housing crossing the first hinge assembly, the second housing and the second hinge assembly, one or more sensors, memory comprising one or more storage media storing instructions, and at least one processor comprising processing circuitry, wherein the instructions, when executed by the at least one processor individually or collectively, cause the electronic device to, in a state displaying a video in the flexible display, identify, by using the one or more sensors, a first angle by which the first housing and the second housing are folded based on the first hinge assembly and a second angle by which the second housing and the third housing are folded based on the second hinge assembly, and based on at least one of the identified first angle and the second angle, control the first speaker to output a first audio channel corresponding to the first speaker and control the second speaker to output a second audio channel corresponding to the second speaker.

In accordance with another aspect of the disclosure, an electronic device is provided. The electronic device includes a first housing, a first speaker positioned at the first housing, a second housing, a first hinge assembly for rotatably connecting the first housing and the second housing, a third housing, a second speaker positioned at the third housing, a second hinge assembly for rotatably connecting the second housing and the third housing, a flexible display disposed from the first housing to the third housing crossing the first hinge assembly, the second housing and the second hinge assembly, one or more sensors, memory comprising one or more storage media storing instructions, and at least one processor comprising processing circuitry. The instructions, when executed by the at least one processor individually and/or collectively, cause the electronic device to, in a state displaying a video in the flexible display, identify, by using the one or more sensors, a first angle by which the first housing and the second housing are folded based on the first hinge assembly and a second angle by which the second housing and the third housing are folded based on the second hinge assembly. The instructions, when executed by the at least one processor individually and/or collectively, cause the electronic device to identify, based on at least one of the first angle or the second angle, speakers respectively corresponding to audio channels associated with the video from among the first speaker and the second speaker. The instructions, when executed by the at least one processor individually and/or collectively, may cause the electronic device to control, based on identifying an audio channel corresponding to the first speaker among the audio channels, the speaker to output the audio channel corresponding to the first speaker. The instructions, when executed by the at least one processor individually and/or collectively, cause the electronic device to control, based on identifying an audio channel corresponding to the second speaker among the audio channels, the second speaker to output the audio channel corresponding to the second speaker.

In accordance with another aspect of the disclosure, a method performed by an electronic device is provided. The method includes identifying, in a state displaying a video in a flexible display of the electronic device, by using one or more sensors of the electronic device, a first angle by which a first housing and a second housing of the electronic device are folded based on a first hinge assembly, and a second angle by which the second housing and a third housing of the electronic device are folded based on a second hinge assembly, identifying, based on at least one of the first angle or the second angle, speakers respectively corresponding to audio channels associated with the video from among a first speaker positioned at the first housing or a second speaker positioned at the third housing, controlling, based on identifying a first audio channel corresponding to the first speaker among the audio channels, the first speaker to output the first audio channel corresponding to the first speaker, and controlling, based on identifying a second audio channel corresponding to the second speaker among the audio channels, the second speaker to output the second audio channel corresponding to the second speaker.

In accordance with another aspect of the disclosure, an electronic device is provided. The electronic device includes a first housing, a first speaker positioned at the first housing, a second housing, a first hinge assembly for rotatably connecting the first housing and the second housing, a third housing, a second speaker positioned at the third housing, a second hinge assembly for rotatably connecting the second housing and the third housing, a flexible display disposed from the first housing to the third housing crossing the first hinge assembly, the second housing and the second hinge assembly, one or more sensors, memory comprising one or more storage media storing instructions, and at least one processor comprising processing circuitry. The instructions, when executed by the at least one processor individually and/or collectively, cause the electronic device to, in a state displaying a video in the flexible display, identify, based on the one or more sensors, a motion by which the flexible display is folded based on one of the first hinge assembly or the second hinge assembly. The instructions, when executed by the at least one processor individually and/or collectively, cause the electronic device to, based on the motion, display the video in a second portion larger than a first portion, among flat portions of the flexible display distinguished by a hinge assembly folded by the motion. The instructions, when executed by the at least one processor individually and/or collectively, cause the electronic device to control one of the first speaker or the second speaker to output audio associated with the video through a speaker included in a housing corresponding to the second portion in which the video is displayed, among the first housing or the third housing.

In accordance with another aspect of the disclosure, a method of an electronic device is provided. The method includes, in a state displaying a video in a flexible display of the electronic device, identifying, based on one or more sensors of the electronic device, a motion by which the flexible display is folded based on one of a plurality of hinge assemblies of the electronic device. The method includes, based on the motion, displaying the video in a second portion larger than a first portion, among flat portions of the flexible display distinguished by a hinge assembly folded by the motion. The method includes controlling one of the first speaker or the second speaker to output audio associated with the video through a speaker included in a housing corresponding to the second portion in which the video is displayed, among the first housing or the third housing.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations include identifying, in a state displaying a video in a flexible display of the electronic device, by using one or more sensors of the electronic device, a first angle by which a first housing and a second housing of the electronic device are folded based on a first hinge assembly, and a second angle by which the second housing and a third housing of the electronic device are folded based on a second hinge assembly, identifying, based on at least one of the first angle or the second angle, speakers respectively corresponding to audio channels associated with the video from among a first speaker positioned at the first housing or a second speaker positioned at the third housing, controlling, based on identifying an audio channel corresponding to the first speaker among the audio channels, the first speaker to output the audio channel corresponding to the first speaker, and controlling, based on identifying an audio channel corresponding to the second speaker among the audio channels, the second speaker to output the audio channel corresponding to the second speaker.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B illustrate a deformable electronic device according to various embodiments of the disclosure;

FIG. 2 illustrates an example of a block diagram of an electronic device according to an embodiment of the disclosure;

FIG. 3 illustrates a flowchart of an operation of an electronic device distinguished by software applications according to an embodiment of the disclosure;

FIG. 4 illustrates different states of an electronic device distinguished by an angle of a folding axis according to an embodiment of the disclosure;

FIG. 5 illustrates an example of an operation of an electronic device according to deformation in folding axes according to an embodiment of the disclosure;

FIGS. 6A and 6B illustrate an example of an operation of an electronic device displaying a video in at least one of portions of a flexible display distinguished by folding axes according to various embodiments of the disclosure;

FIGS. 7A and 7B illustrate an example of an operation of an electronic device displaying videos in portions of a flexible display distinguished by folding axes according to various embodiments of the disclosure;

FIG. 8 illustrates an example of an operation of an electronic device displaying visual objects for adjusting volumes corresponding to videos according to an embodiment of the disclosure;

FIG. 9 illustrates an example of an operation of an electronic device obtaining information for controlling speakers in each of different states of the electronic device distinguished by deformation in folding axes according to an embodiment of the disclosure;

FIG. 10 illustrates a flowchart of an operation of an electronic device distinguished by software applications according to an embodiment of the disclosure;

FIG. 11 illustrates a graph for describing an operation of an electronic device adjusting a volume based on angles of folding axes according to an embodiment of the disclosure;

FIG. 12 illustrates an example of a flowchart of an electronic device according to an embodiment of the disclosure;

FIG. 13 illustrates an example of a flowchart of an electronic device according to an embodiment of the disclosure;

FIG. 14 illustrates an example of a flowchart of an electronic device according to an embodiment of the disclosure; and

FIG. 15 is a block diagram of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In relation to the description of the drawings, a reference numeral may be used for a similar component. In the document, an expression such as “A or B,” “at least one of A and/or B,” “A, B or C,” or “at least one of A, B and/or C,” and the like may include all possible combinations of items listed together. Expressions such as “1^{st},” “2^{nd},” “first” or “second,” and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

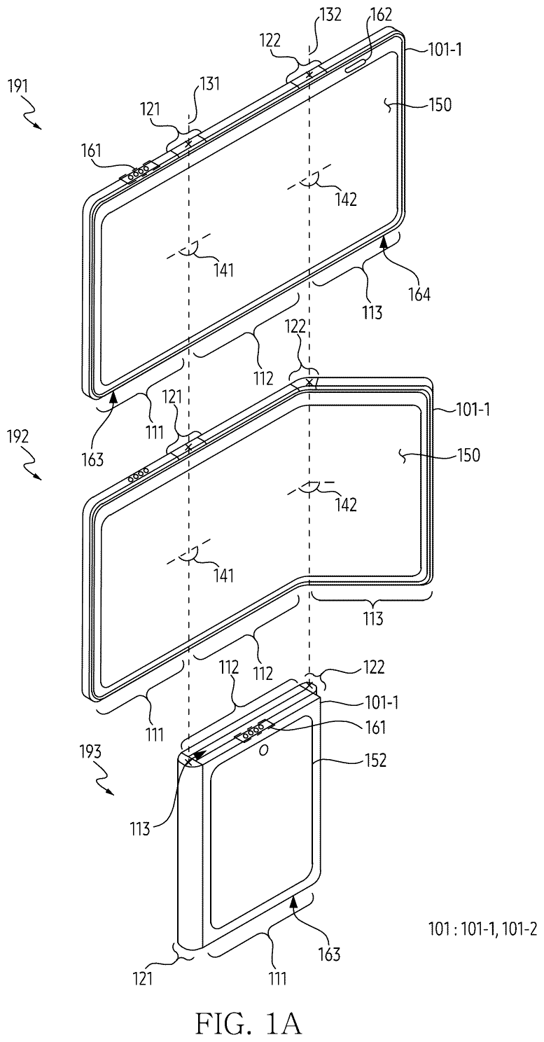

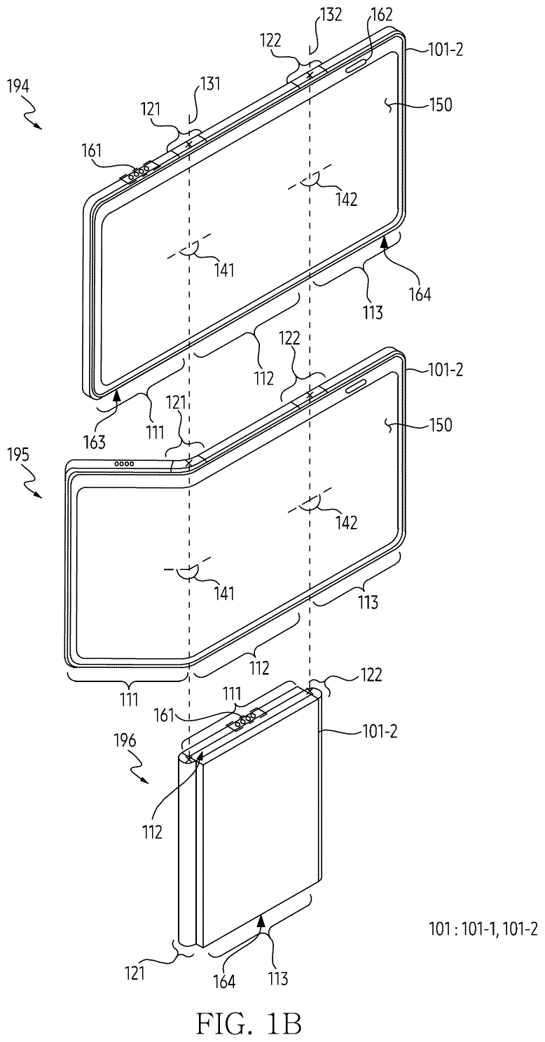

FIGS. 1A and 1B illustrate a deformable electronic device 101 according to various embodiments of the disclosure. In an embodiment, in terms of being owned by a user, an electronic device 101 may be referred to as a terminal (or a user terminal). The terminal may include, for example, a personal computer (PC) such as a laptop and a desktop. The terminal may include, for example, a smartphone, a smartpad, and/or a tablet PC. The terminal may include a smart accessory such as a smartwatch and/or a head-mounted device (HMD).

Referring to FIGS. 1A and 1B, according to an embodiment, the electronic device 101 may include a deformable housing. Based on deformability, the housing of the electronic device 101 may be divided into a plurality of portions. For example, the housing of the electronic device 101 of FIGS. 1A and 1B may include a first housing 111 and a second housing 112, and a first hinge assembly 121 for rotatably connecting the first housing 111, and the second housing 112. By the first hinge assembly 121, a relative location, an angle, a shape, and/or a distance of the first housing 111 and the second housing 112, which are rigid bodies, may be changed by an external force. The housing of the electronic device 101 may include the second housing 112, a third housing 113, and a second hinge assembly 122 for rotatably connecting the second housing 112, and the third housing 113. By the second hinge assembly 122, a relative location, an angle, a shape, and/or a distance of the second housing 112 and the third housing 113, which are rigid bodies, may be changed by an external force.

Referring to FIGS. 1A and 1B, a first folding axis 131 is a rotation axis of the first housing 111 and the second housing 112 connected through the first hinge assembly 121, and may be formed in the first hinge assembly 121. As the first housing 111 and/or the second housing 112 are rotated based on the first folding axis 131, a first angle 141 between the first housing 111, the first hinge assembly 121, and the second housing 112 may be changed. A second folding axis 132 is a rotation axis of the second housing 112 and the third housing 113 connected through the second hinge assembly 122, and may be formed in the second hinge assembly 122. As the second housing 112 and/or the third housing 113 are rotated based on the second folding axis 132, a second angle 142 between the second housing 112, the second hinge assembly 122, and the third housing 113 may be changed.

Referring to FIGS. 1A and 1B, according to an embodiment, the electronic device 101 may include a flexible display 150 positioned on a surface (e.g., a front surface of the electronic device 101) of the first housing 111, the second housing 112, and the third housing 113. For example, the flexible display 150 may be disposed from the first housing 111 to the third housing 113 crossing the first hinge assembly 121, the second housing 112, and the second hinge assembly 122. Hereinafter, the first angle 141 may correspond to an angle between the surface of the first housing 111 and a surface of the second housing 112 on which the flexible display 150 is positioned which may be folded by the first folding axis 131 of the first hinge assembly 121. Hereinafter, the second angle 142 may correspond to an angle between the surface of the second housing 112 and a surface of the third housing 113 in which the flexible display 150 is positioned which may be folded by the second folding axis 132 of the second hinge assembly 122.

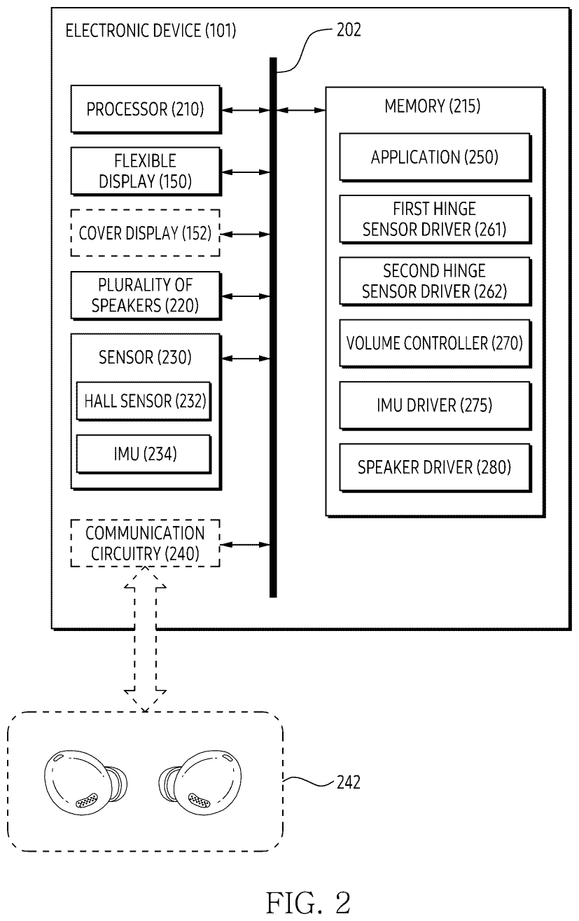

Referring to FIGS. 1A and 1B, according to an embodiment, the electronic device 101 may include a first speaker 161 and/or a third speaker 163 positioned in the first housing 111. The electronic device 101 may include a second speaker 162 and/or a fourth speaker 164 positioned in the third housing 113. The third speaker 163 may be positioned at a second edge of the first housing 111 opposite to a first edge of the first housing 111 where the first speaker 161 is positioned. The fourth speaker 164 may be positioned at a second edge of the third housing 113 opposite to a first edge of the third housing 113 where the second speaker 162 is positioned. Although the second speaker 162 positioned on the surface of the third housing 113 where the flexible display 150 is positioned and the first speaker 161, the third speaker 163, and the fourth speaker 164 positioned on a lateral surface connected a front surface of the electronic device 101 are exemplarily illustrated, locations of the speakers (e.g., the first speaker 161 to the fourth speaker 164) included in the electronic device 101 are not limited to locations illustrated in FIGS. 1A and 1B. An example of hardware included in the electronic device 101 to control a plurality of speakers and the flexible display 150 will be described with reference to FIG. 2.

Referring to FIGS. 1A and 1B, different shapes of electronic device 101 supporting the deformability based on a plurality of folding axes (e.g., the first folding axis 131 and/or the second folding axis 132) are illustrated. Referring to FIG. 1A, a first electronic device 101-1 including the flexible display 150 that is fully covered visually by the first housing 111 to the third housing 113 folded along the first folding axis 131 and the second folding axis 132 is illustrated. Referring to FIG. 1A, different states (e.g., a first state 191, a second state 192, and a third state 193) of the first electronic device 101-1 distinguished by the first angle 141 and the second angle 142 are illustrated. The first state 191 of the first electronic device 101-1 in which the first angle 141 and the second angle 142 are substantially a straight angle (e.g., approximately 180°) may be referred to as a fully unfolded state, an opened state, an unfolded state, a flat state, and/or a planar state. In the first state 191, the flexible display 150 positioned from the first housing 111 to the third housing 113 may have a substantially flat shape. In the first state 191, a single plane may be formed on the front surface of the electronic device 101 in which the flexible display 150 is positioned.

Referring to FIG. 1A, the second state 192 of the first electronic device 101-1 that the first angle 141 is substantially the straight angle and the second angle 142 is an angle smaller than the straight angle is illustrated. A state of the first electronic device 101-1 including the second state 192, in which the first angle 141 and/or the second angle 142 is smaller than the straight angle, may be referred to as an in-folded state, a sub-unfolded state (or a sub-folded state), and/or a concave state. Although it is illustrated that only the second hinge assembly 122 of the first hinge assembly 121 and the second hinge assembly 122 is folded, an embodiment is not limited thereto, and the sub-folded state may include a state that both the first angle 141 and the second angle 142 are smaller than the straight angle and greater than 0°. In the sub-folded state, a plurality of planes may be formed by the flexible display 150 folded by at least one hinge assembly. Referring to the second state 192, the flexible display 150 bent by the second hinge assembly 122 may include two flat portions distinguished by the second hinge assembly 122. For example, the flat portions of the flexible display 150 distinguished by the second hinge assembly 122 may face different directions.

Referring to FIG. 1A, the third state 193 of the first electronic device 101-1 in which both the first angle 141 and the second angle 142 are substantially 0° may be referred to as a fully folded state, a folded state, and/or a closed state. In the third state 193, the flexible display 150 may be fully visually covered by the first housing 111 to the third housing 113. For example, in the folded state, a size at which the flexible display 150 of the first electronic device 101-1 is exposed to the outside may be substantially zero. Referring to FIG. 1A, the third state 193 that each of a front surface and a rear surface of the third housing 113 in which a portion of the flexible display 150 is positioned is covered by the first housing 111 and the second housing 112 is illustrated, but an embodiment is not limited thereto. The first electronic device 101-1 including the flexible display 150 that is fully visually covered in the folded state may include a cover display 152 positioned on a rear surface opposite to the front surface on which the flexible display 150 is positioned. Referring to FIG. 1A, according to an embodiment, the first electronic device 101-1 may include the cover display 152 positioned on a second surface of the first housing 111 opposite to a first surface of the first housing 111 on which a portion of the flexible display 150 is positioned.

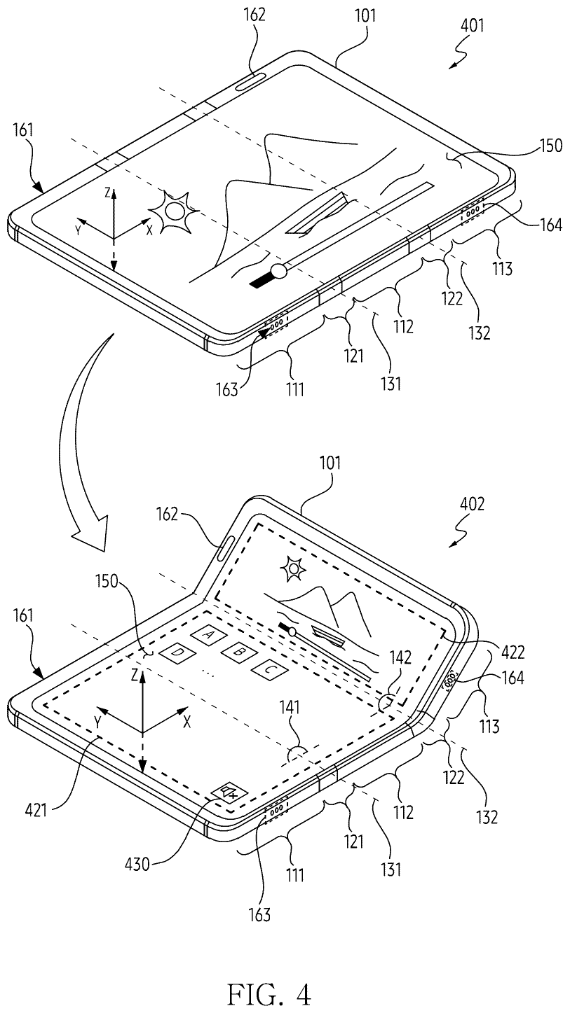

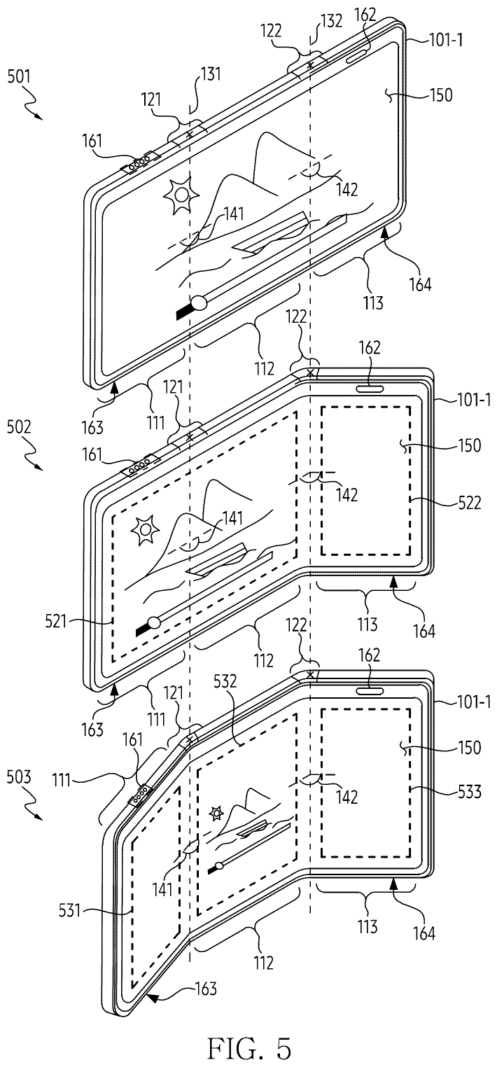

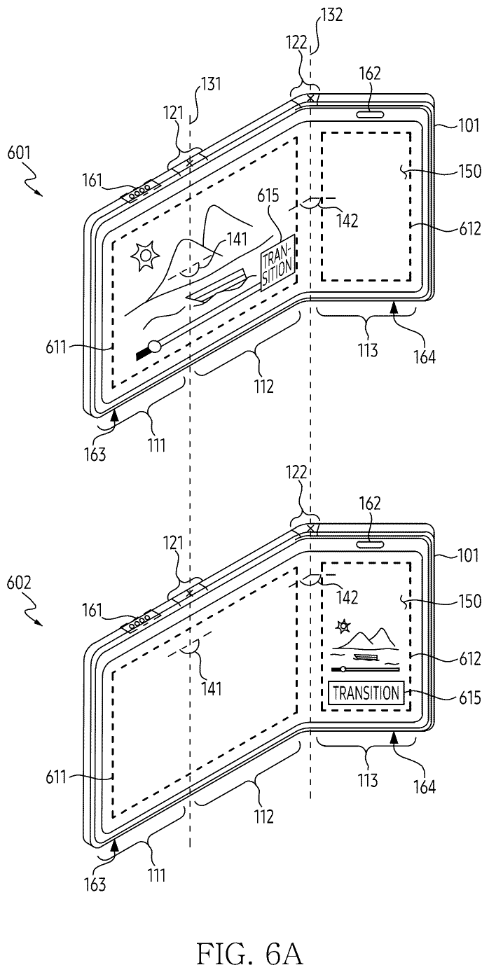

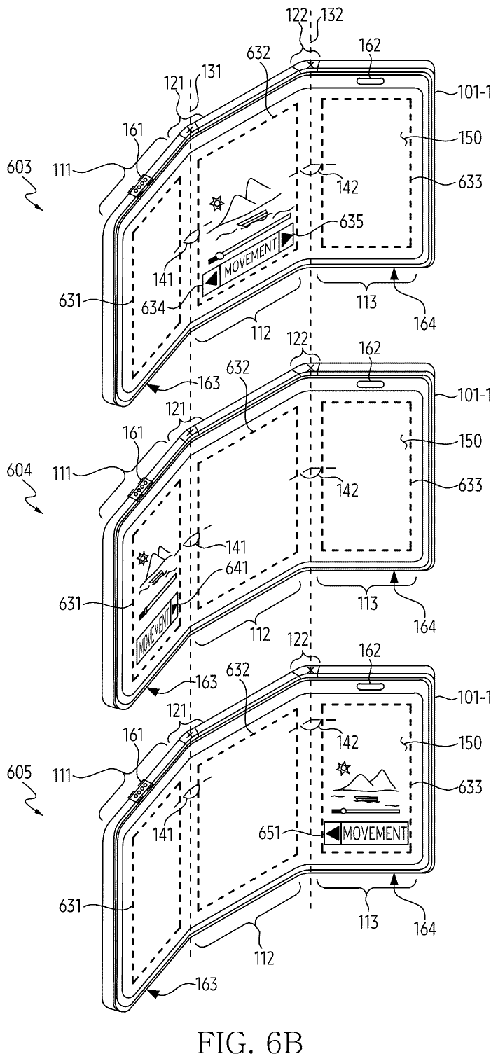

According to an embodiment, while playing media content including a video and audio, the electronic device 101 may change, based on a shape of the flexible display 150, a location and/or a size of the flexible display 150 in which the video is played, and at least one speaker through which the audio is outputted. An operation of the electronic device 101 controlling a plurality of speakers (e.g., the first speaker 161 to the fourth speaker 164) based on the shape of the flexible display 150 will be is described with reference to FIGS. 4, 6A and/or 9. An operation of the first electronic device 101-1 controlling the speaker based on the shape described with reference to the states 191, 192, and 193 will be described with reference to FIGS. 5, 6B, 7A, 8 and/or 11.

Referring to FIG. 1A, the first electronic device 101-1 including the flexible display 150 configured to be folded at an angle smaller than the straight angle along the first folding axis 131 and the second folding axis 132 may be referred to as a G-shaped foldable electronic device. Referring to FIG. 1B, different shapes of a second electronic device 101-2 including the flexible display 150 configured to be folded at an angle greater than the straight angle along at least one of the first folding axis 131 or the second folding axis 132 will be illustrated. The second electronic device 101-2 may be referred to as an S (or Z)-shaped foldable electronic device.

Referring to FIG. 1B, different states (e.g., a fourth state 194 to a sixth state 196) of the second electronic device 101-2 distinguished by the first angle 141 and the second angle 142 will be illustrated. The fourth state 194 of the second electronic device 101-2 may correspond to the first state 191 of the first electronic device 101-1 of FIG. 1A. In the fourth state 194 corresponding to the unfolded state, a flat plane may be formed by the flexible display 150.

Referring to FIG. 1B, the fifth state 195 of the second electronic device 101-2 that the first angle 141 is greater than the straight angle and the second angle 142 is substantially the straight angle will be illustrated. A state of the second electronic device 101-2 that the first angle 141 and/or the second angle 142 are greater than the straight angle and smaller than 360° may be referred to as an out-folded state and/or a convex state. Although only the first angle 141 of the first angle 141 and the second angle 142 is illustrated to be greater than the straight angle, an embodiment is not limited thereto. In the convex state including the fifth state 195, a plurality of planes formed by the flexible display 150 folded by the first hinge assembly 121 may face different directions.

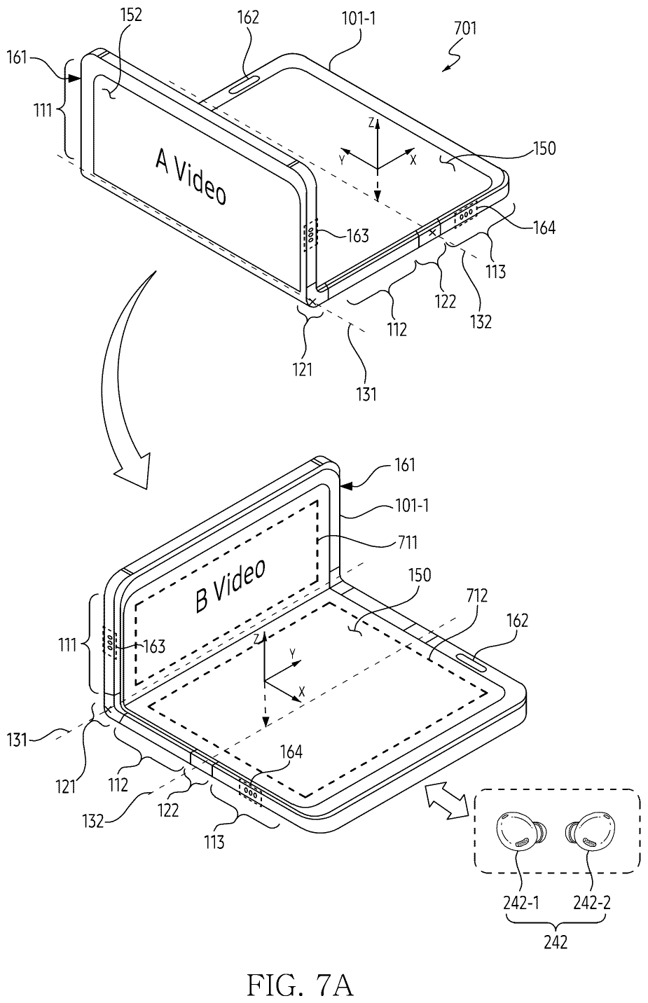

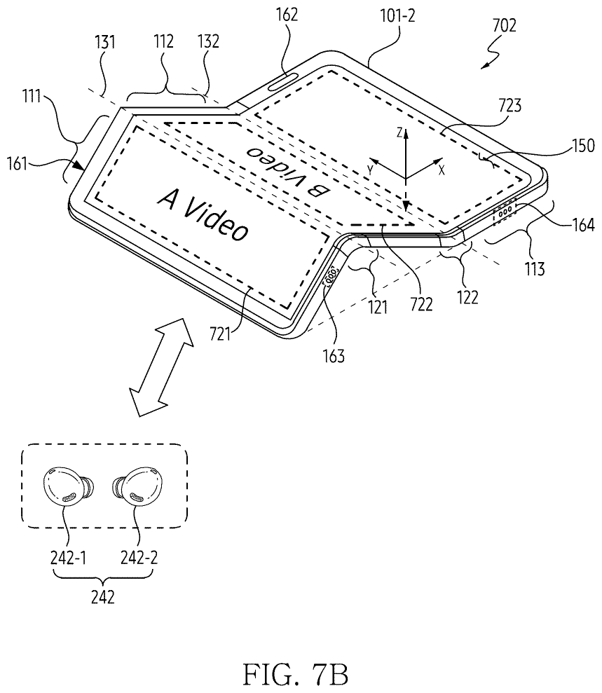

Referring to FIG. 1B, the sixth state 196 of the second electronic device 101-2 that the first angle 141 is substantially 360°, and the second angle 142 is substantially 0° may be referred to as a fully folded state, a folded state, and/or a closed state. In the sixth state 196, among portions of the flexible display 150 positioned in each of the first housing 111 to the third housings 113, only a portion of the flexible display 150 positioned on the first housing 111 may be exposed to the outside. An operation of the second electronic device 101-2 controlling a speaker based on the shape described with reference to the states 194, 195, and 196 will be described with reference to FIG. 7B.

As described above, according to an embodiment, the electronic device 101 may be a multi-foldable electronic device including a plurality of folding axes (e.g., the first folding axis 131 and/or the second folding axis 132). The electronic device 101 may change a signal path for outputting audio to speakers of the electronic device 101 such as the first speaker 161 to the fourth speaker 164 and/or volumes of the speakers based on a shape of the electronic device 101 folded by the plurality of folding axes. The shape of the electronic device 101 may be distinguished by parameters including the first angle 141 and/or the second angle 142. For example, the electronic device 101 may control the first speaker 161 to the fourth speaker 164 using the first angle 141 and/or the second angle 142. In an embodiment, in order to enhance a user experience associated with the audio, the electronic device 101 may change mapping of the speakers and audio channels (e.g., two audio channels distinguished for stereo), based on the shape.

Hereinafter, hardware included in the electronic device 101 changing the mapping of the speakers and the audio channels will be described with reference to FIG. 2.

FIG. 2 illustrates an example of a block diagram of an electronic device 101 according to an embodiment of the disclosure. Referring to FIG. 2, according to an embodiment, the electronic device 101 may include at least one of a processor 210, memory 215, a flexible display 150, a plurality of speakers 220 (e.g., the first speaker 161 to the fourth speaker 164 of FIGS. 1A and/or 1B), or a sensor 230. The processor 210, the memory 215, the flexible display 150, the plurality of speakers 220, and the sensor 230 may be electrically and/or operably coupled with each other by an electronical component such as a communication bus 202. In an embodiment, the electronic device 101 may further include a cover display 152 and/or communication circuitry 240.

In an embodiment, hardware of the electronic device 101 being operably connected may mean that a direct connection or an indirect connection between hardware is established by wire or wirelessly so that second hardware is controlled by first hardware among the hardware. Although illustrated based on different blocks, an embodiment is not limited thereto, and a portion (e.g., at least a portion of the processor 210, the memory 215, and the communication circuitry 240) of the hardware of FIG. 2 may be included in a single integrated circuit such as a system on a chip (SoC). The hardware of the electronic device 101 divided into blocks may be located in a first housing 111 to a third housing 113 described with reference to FIGS. 1A and 1B. A type and/or the number of the hardware included in the electronic device 101 is not limited as illustrated in FIG. 2. For example, the electronic device 101 may include only a portion of a hardware component illustrated in FIG. 2.

According to an embodiment, the processor 210 of the electronic device 101 may include hardware for processing data based on one or more instructions. For example, the hardware for processing the data may include an arithmetic and logic unit (ALU), a floating point unit (FPU), a field programmable gate array (FPGA), a central processing unit (CPU), and/or an application processor (AP). The number of the processor 210 may be one or more. The processor 210 may have a structure of a multi-core processor such as a dual core, a quad core, or a hexa core.

According to an embodiment, the memory 215 of the electronic device 101 may include a hardware component for storing data inputted to and/or outputted from the processor 120 and/or an instruction processed by the processor 120. For example, the memory 215 may include volatile memory such as random-access memory (RAM), and/or non-volatile memory such as read-only memory (ROM). For example, the volatile memory may include at least one of dynamic RAM (DRAM), static RAM (SRAM), cache RAM, and pseudo SRAM (PSRAM). For example, the non-volatile memory may include at least one of programmable ROM (PROM), erasable PROM (EPROM), electrically erasable PROM (EEPROM), flash memory, a hard disk, a compact disk, a solid state drive (SSD), and an embedded multimedia card (eMMC).

According to an embodiment, the flexible display 150 of the electronic device 101 may output visualized information (e.g., a screen of FIGS. 4, 5, 6A, 6B, 7A, 7B, 8, 9 and/or 11) to a user. For example, the flexible display 150 may visualize information provided by the processor 210 such as a graphic processing unit (GPU). The flexible display 150 may include a liquid crystal display (LCD), a plasma display panel (PDP), and/or one or more light emitting diode (LED). The LED may include an organic LED (OLED). The flexible display 150 may include electronic paper. As described above with reference to FIGS. 1A and 1B, the flexible display 150 may have at least a partially curved shape or a deformable shape.

According to an embodiment, the flexible display 150 of the electronic device 101 may include a sensor (e.g., a touch sensor panel (TSP)) for detecting an external object (e.g., a user's finger) on the flexible display 150. For example, based on the TSP, the electronic device 101 may detect an external object that is in contact with the flexible display 150 or is floating on the flexible display 150. In response to detecting the external object, the electronic device 101 may execute a function associated with a specific visual object corresponding to a location of the external object on the flexible display 150 among visual objects being displayed in the flexible display 150.

According to an embodiment, the cover display 152 of the electronic device 101 may be provided to output visualized information to the user, similar to the flexible display 150. As described above with reference to FIG. 1A, the cover display 152 may be positioned on a different surface from a surface of the electronic device 101 in which the flexible display 150 is positioned. A location of the cover display 152 may be positioned on a surface of a viewable housing in a state that the flexible display 150 is covered (e.g., the third state 193 of FIG. 1A). The cover display 152 may be implemented similarly to the flexible display 150. Among descriptions of the cover display 152, a description overlapping the flexible display 150 may be omitted for convenience of the description.

According to an embodiment, the plurality of speakers 220 of the electronic device 101 may be configured to output an audio signal provided from the processor 210. Signal paths electrically connecting the processor 210 and each of the plurality of speakers 220 may include at least one switch (e.g., a transistor) and/or an amplifier controlled by the processor 210. The processor 210 may change a volume and/or a frequency of a speaker corresponding to a signal path among the plurality of speakers 220, using a switch and/or an amplifier on the signal path. The processor 210 may activate or deactivate the speaker by changing a voltage and/or a current of a power signal provided to the speaker. Based on independently formed signal paths, the processor 210 may individually control the plurality of speakers 220.

According to an embodiment, the sensor 230 of the electronic device 101 may generate electronic information that may be processed by the processor 210 and/or the memory 215 from non-electronic information associated with the electronic device 101. For example, the sensor 230 may include a global positioning system (GPS) sensor for detecting a geographic location of the electronic device 101. In addition to the GPS method, the sensor 230 may generate information indicating the geographic location of the electronic device 101 based on a global navigation satellite system (GNSS) such as galileo and/or beidou (compass). The information may be stored in the memory 215, or processed by the processor 210, and/or transmitted to another electronic device distinct from the electronic device 101 through the communication circuitry 240. The sensor 230 is not limited to the above description and may include an image sensor, an illuminance sensor, a proximity sensor, a grip sensor, and/or a ToF sensor for detecting electromagnetic waves including light.

Referring to FIG. 2, as an example of the sensor 230, a Hall sensor 232 and an inertial measurement unit (IMU) 234 are illustrated. The Hall sensor 232 may include a magnet and a magnetic field sensor measuring a change in a magnetic field formed by the magnet. The magnet and the magnetic field sensor may be positioned at different portions of a housing of the electronic device 101. Based on the change in the magnetic field measured by the magnetic field sensor, the Hall sensor 232 may identify a distance between the portions. In an embodiment in which the electronic device 101 includes a deformable housing (e.g., the first housing 111, the second housing 112, and/or a third housing 113 of FIGS. 1A and 1B), the electronic device 101 may identify a shape of the housing, using the Hall sensor 232 including the magnet and the magnetic field sensor positioned at the different portions of the housing. For example, the Hall sensor 232 may output sensor data indicating the distance and/or the shape of the housing.

According to an embodiment, the IMU 234 may include an acceleration sensor, a gyro sensor, a geomagnetic sensor, or any combination thereof. The acceleration sensor may output an electrical signal indicating gravitational acceleration and/or acceleration of each of a plurality of axes (e.g., an x-axis, a y-axis, and a z-axis) perpendicular to each other. The gyro sensor 233 may output an electric signal indicating an angular velocity (e.g., an angular velocity based on a roll, a pitch, and/or a yaw) of each of the plurality of axes. The geomagnetic sensor may output an electric signal indicating a size of the magnetic field formed in the electronic device 101 along each of the plurality of axes (e.g., the x-axis, the y-axis, and/or the z-axis). The processor 210 may repeatedly obtain data indicating the acceleration, the angular velocity, and/or the size of the magnetic field from the IMU 234 based on a preset period (e.g., 1 millisecond). Using the Hall sensor 232 and/or the IMU 234, the processor 210 may identify parameters (e.g., the first angle 141 and/or the second angle 142 of FIGS. 1A and 1B) associated with the shape of the electronic device 101. Based on the parameters, the processor 210 may identify a current shape of the electronic device 101 among preset shapes (e.g., an unfolded state, a sub-folded state, and/or a folded state) for distinguishing the shape of the electronic device 101.

According to an embodiment, the communication circuitry 240 of the electronic device 101 may include hardware for supporting transmission and/or reception of information between the electronic device 101 and an external electronic device 242. For example, the communication circuitry 240 may include at least one of a MODEM, an antenna, and an optic/electronic (O/E) converter. The communication circuitry 240 may support transmission and/or reception of an electrical signal based on various types of protocol such as ethernet, a local area network (LAN), a wide area network (WAN), a wireless fidelity (WiFi), near field communication (NFC), Bluetooth, bluetooth low energy (BLE), ZigBee, long term evolution (LTE), fifth generation (5G) new radio (NR), and/or sixth generation (6G). Although the external electronic device 242, which is an example of a wireless earphone, is exemplarily illustrated, a type of the external electronic device accessible by the electronic device 101 through the communication circuitry 240 is not limited to the wireless earphone.

Although not illustrated, according to an embodiment, the electronic device 101 may include an output means for outputting information in a different form other than a visualized form. For example, the electronic device 101 may include a motor for providing haptic feedback based on vibration.

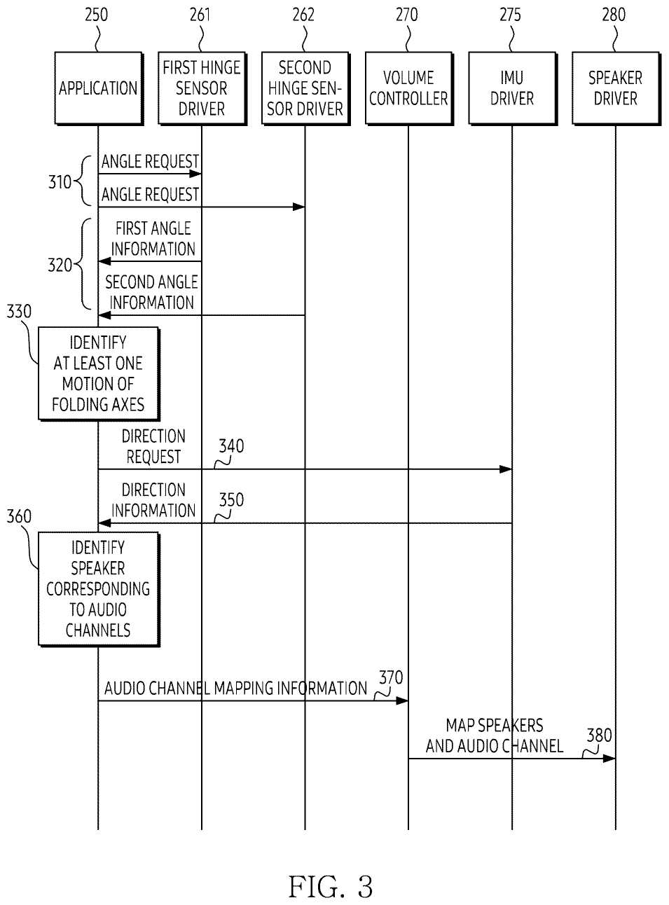

According to an embodiment, in the memory 215 of the electronic device 101, one or more instructions (or commands) indicating a calculation and/or an operation to be performed by the processor 210 on data may be stored. A set of one or more instructions may be referred to as firmware, an operating system, a process, a routine, a sub-routine and/or an application. For example, when a set of a plurality of instructions distributed in a shape of the operating system, the firmware, a driver, and/or the application is executed, the electronic device 101 and/or the processor 210 may perform at least one of operations of FIGS. 3, 10, and 12 to 14. Hereinafter, installation of an application in the electronic device 101 may mean that one or more instructions provided in a form of the application are stored in the memory 215 of the electronic device 101, and the one or more applications are stored in a format (e.g., a file with an extension preset by the operating system of the electronic device 101) executable by the processor 210 of the electronic device 101.

Referring to FIG. 2, programs stored in the memory 215 are illustrated as different blocks. For example, the processor 210 may execute at least one of an application 250, a first hinge sensor driver 261, a second hinge sensor driver 262, a volume controller 270, an IMU driver 275, or a speaker driver 280. Based on execution of the application 250, the processor 210 may perform at least one operation having the user of the electronic device 101 as a target. For example, in a state that the application 250 is executed, the processor 210 may output media content stored in the memory 215 or received in a form of a bitstream through the communication circuitry 240. The media content may include a video, an image, text, audio, or a combination thereof. In order to output the media content, the processor 210 may control the flexible display 150, the cover display 152, and/or the plurality of speakers 220. In order to output a video and/or audio synchronized with each other in the media content, the processor 210 may simultaneously control the flexible display 150 and the plurality of speakers 220.

Referring to FIG. 2, based on execution of the first hinge sensor driver 261, the processor 210 may obtain information on a first hinge assembly (e.g., the first hinge assembly 121 of FIGS. 1A and 1B) among a plurality of hinge assemblies of the electronic device 101. The information obtained from the first hinge sensor driver 261 may include an angle (e.g., the first angle 141 of FIGS. 1A and 1B) of the flexible display 150 folded in the first hinge assembly and/or data to be used to calculate the angle. For example, the first hinge sensor driver 261 may be a program for controlling a sensor for measuring an angle between the first housing and the second housing connected by the first hinge assembly. The sensor for measuring the angle between the first housing and the second housing may include the Hall sensor 232 of FIG. 2. An embodiment is not limited thereto, and the sensor for measuring the angle between the first housing and the second housing may include the IMU 234 positioned in each of the first housing and the second housing. Similarly, based on execution of the second hinge sensor driver 262, the processor 210 may obtain information on a second hinge assembly (e.g., the second hinge assembly 122 of FIGS. 1A and 1B) among the plurality of hinge assemblies.

Referring to FIG. 2, based on execution of the volume controller 270, the processor 210 may change at least one volume of the plurality of speakers 220. Based on the execution of the volume controller 270, the processor 210 may obtain audio signals to be outputted to the plurality of speakers 220 from applications executed by the processor 210. Based on the execution of the volume controller 270, the processor 210 may identify the audio signals to be outputted through the plurality of speakers 220 and mapping (or a relationship) between the plurality of speakers 220.

Referring to FIG. 2, based on execution of the IMU driver 275, the processor 210 may control the IMU 234 or obtain and/or receive sensor data from the IMU 234. Based on the execution of the IMU driver 275, the processor 210 may periodically (or repeatedly) obtain the sensor data from the IMU 234. Based on the execution of the IMU driver 275, the processor 210 may perform an operation for controlling the IMU 234.

Referring to FIG. 2, based on execution of the speaker driver 280, the processor 210 may control at least one transistor included in the signal paths between the processor 210 and the plurality of speakers 220, or may directly control the plurality of speakers 220. The processor 210 executing the speaker driver 280 may generate a control signal for activating, deactivating, and/or adjusting a volume of the plurality of speakers 220, based on the mapping identified based on the execution of the volume controller 270, and transmit the control signal to at least one of the plurality of speakers 220.

As described above, according to an embodiment, the processor 210 of the electronic device may, in a state displaying the video in the flexible display 150, identify, by using the sensor 230, a first angle by which the first housing and the second housing are folded based on the first hinge assembly and a second angle by which the second housing and the third housing are folded based on the second hinge assembly. The processor 210 may identify, based on at least one of the first angle or the second angle, speakers respectively corresponding to audio channels associated with the video from among the plurality of speakers 220. For example, the processor 210 identifying an audio channel corresponding to the first speaker among the audio channels may control the first speaker to output the audio channel corresponding to the first speaker. For example, the processor 210 identifying an audio channel corresponding to the second speaker among the audio channels may be configured to control the second speaker to output the audio channel corresponding to the second speaker.

Hereinafter, an example of an operation of the electronic device 101 based on execution of one or more software applications stored in the memory 215 will be described with reference to FIG. 3.

FIG. 3 illustrates a flowchart of an operation of an electronic device distinguished by software applications according to an embodiment of the disclosure. The operation of the electronic device described with reference to FIG. 3 may be performed by the electronic device 101 of FIGS. 1A, 1B and 2 and/or the processor 210 of FIG. 2.

In the following embodiment, each operation may be sequentially performed, but is not necessarily performed sequentially. For example, an order of each operation may be changed, and at least two operations may be performed in parallel.

Referring to FIG. 3, an operation of a processor performed based on execution of an application 250 will be described. The operation of FIG. 3 may be performed by the processor in a state that the application 250 for playing media content (e.g., a video and/or audio) is executed. For example, the processor may display a video through a display (e.g., the flexible display 150 and/or the cover display 152 of FIGS. 1A, 1B and 2), based on the execution of the application 250. While displaying the video, the processor may perform at least one of operations of FIG. 3. An embodiment is not limited thereto.

Referring to FIG. 3, in an operation 310, the processor may obtain an angle using hinge sensor drivers (e.g., a first hinge sensor driver 261 and/or a second hinge sensor driver 262) based on the execution of the application 250. The processor may perform the operation 310 by executing a preset application programming interface (API) for requesting (or obtaining) angle information. The preset API may be indicated by instructions included in the application 250. For example, the processor may execute the API for registering an object (e.g., an event listener) to repeatedly (or periodically) obtain sensor data (e.g., sensor data of a first hinge sensor corresponding to the first hinge sensor driver 261) to the first hinge sensor driver 261. Similarly, the processor may register an object for repeatedly (or periodically) providing sensor data of a second hinge sensor corresponding to the second hinge sensor driver 262 to the second hinge sensor driver 262.

Referring to FIG. 3, in an operation 320, the processor may provide angle information identified using each of hinge sensors for the execution of the application 250 based on execution of the first hinge sensor driver 261 and/or the second hinge sensor driver 262. Providing the angle information by the processor based on the operation 320 may be repeatedly (or periodically) performed based on the execution of the first hinge sensor driver 261 and/or the second hinge sensor driver 262. Providing the angle information for the execution of the application 250 may include executing preset instructions (e.g., a callback function (or a sub-routine) preset by an object registered in a hinge sensor driver) included in the application 250, based on the angle information. Based on the operation 320, the processor may obtain first angle information and/or second angle information to be used for the execution of the application 250. The first angle information may be obtained based on the execution of the first hinge sensor driver 261, and may include the sensor data of the first hinge sensor corresponding to the first hinge sensor driver 261. The second angle information may be obtained based on the execution of the second hinge sensor driver 262, and may include the sensor data of the second hinge sensor corresponding to the second hinge sensor driver 262. Based on the operation 320, the processor may obtain angles of a plurality of folding axes included in the electronic device for the execution of the application 250.

Referring to FIG. 3, in an operation 330, the processor may identify at least one motion of folding axes (e.g., the first folding axis 131 and/or the second folding axis 132 of FIGS. 1A and 1B) of the electronic device using the first angle information and/or the second angle information. For example, the processor may identify a motion by which a flexible display (e.g., the flexible display 150 of FIGS. 1A, 1B, and/or 2) of the electronic device is folded based on one of hinge assemblies corresponding to each of the folding axes. The motion may be generated by an external force applied to a housing of the electronic device. For example, the motion may be generated by an external force applied to the housing by a user for deformation of the electronic device. Based on the operation 330, the processor may determine whether to execute a function for reacting to the deformation of the electronic device among functions of the application 250. For example, based on identifying the motion of the operation 330, the processor may perform an operation 340.

Referring to FIG. 3, in the operation 340, the processor may execute a function for requesting a direction (or an orientation) of the electronic device to the IMU driver 275, based on the execution of the application 250. Based on the request, the processor may obtain a direction of the electronic device using the IMU driver 275. The processor may perform the operation 340 by executing a preset API for requesting (or obtaining) the direction. The preset API may be indicated by instructions included in the application 250. For example, the processor may execute an API for registering an object (e.g., an event listener) to the IMU driver 275 for obtaining (or returning) the direction of the electronic device. A direction of the operation 340 may be associated with a direction of gravity applied to the electronic device. For example, the direction of operation 340 may be associated with a direction (e.g., a direction of a normal line of the flexible display) in which the flexible display of the electronic device faces. In case that the flexible display is at least partially folded or bent, the direction of operation 340 may be associated with a direction in which at least one of flat portions of the flexible display distinguished by one or more folding axes of the folded flexible display faces.

Referring to FIG. 3, in an operation 350, the processor may provide direction information indicating the direction of the electronic device for the execution of the application 250 based on execution of the IMU driver 275. Providing the direction information by the processor based on the operation 350 may be performed based on the execution of IMU driver 275. For example, the processor may execute a sub-routine for processing the direction information among the instructions of the application 250, based on the operation 350. The sub-routine of the application 250 may be executed based on the direction information obtained according to the execution of the IMU driver 275.

Referring to FIG. 3, in an operation 360, the processor may identify a speaker corresponding to audio channels. For example, the processor may identify mapping between audio channels and one or more speakers according to a shape of the electronic device described with reference to FIGS. 4, 5, 6A, 6B, 7A, 7B, 8, and 9. The audio channels of the operation 360 may include audio data synchronized with a video displayed by the processor. The audio channel may include audio data distinguished by the speaker. For example, the processor may identify a plurality of audio channels to be provided independently (or individually) to a plurality of speakers from media content. For example, an audio channel to be provided as a speaker located adjacent to a user's left ear may be referred to as a left channel, and an audio channel to be provided as a speaker located adjacent to a user's right ear may be referred to as a right channel. In case that one audio channel is identified from the media content, the identified audio channel may be referred to as a mono channel. In case that two audio channels are identified from the media content, the identified two audio channels may be referred to as stereo channels. Stereo may mean providing the plurality of audio channels to distinguish sound outputted to the user's two ears. Based on stereo-based audio channels, by controlling speakers, the processor may provide a sense of space to the user.

According to an embodiment, the processor of the electronic device may identify the mapping between the audio channels and the speakers by using at least one of the angle information obtained based on the operation 320 and the direction information obtained based on the operation 350. For example, the processor may identify the mapping based on a posture, a shape, and/or a direction of the electronic device indicated by the angle information and/or the direction information. The processor may obtain mapping information including at least one of an audio channel corresponding to each of the plurality of speakers and volumes of each of the plurality of speakers. For example, the mapping information may include parameters (e.g., flags) indicating whether to activate each of the plurality of speakers. For example, the mapping information may include an identifier of the audio channel mapped to each of the plurality of speakers. For example, the mapping information may include parameters indicating volumes of each of the plurality of speakers.

Referring to FIG. 3, in an operation 370, the processor may execute a volume controller 270 using the mapping information identified based on the operation 360 performed by the application 250. The volume controller 270 may be a process (e.g., a system service and/or a system process) executed by an operating system (or a framework) of the electronic device to control the plurality of speakers. Based on the volume controller 270 executed based on the mapping information, the processor may perform an operation 380. In the operation 380, the processor may map the plurality of speakers included in the electronic device and the audio channels provided from the application 250, by controlling the speaker driver 280. Based on the mapping of the speakers and the audio channels, the processor may output audio data included in the audio channels to each of the speakers.

Hereinafter, referring to FIGS. 4, 5, 6A, 6B, 7A, 7B, 8, and 8, an operation in which the processor obtains the mapping information between the speakers and the audio channels based on the posture, the shape, and/or the direction of the electronic device identified based on the execution of the application 250 and controls the speakers using the mapping information will be described.

FIG. 4 illustrates different states 401 and 402 of an electronic device distinguished by an angle of a folding axis according to an embodiment of the disclosure. An electronic device 101 of FIGS. 1A, 1B and/or 2 and/or a processor 210 of FIG. 2 may perform an operation described with reference to FIG. 4. For example, the electronic device 101 of FIG. 4 may include the first electronic device 101-1 and the second electronic device 101-2 of FIGS. 1A and 1B. The operation of the electronic device 101 described with reference to FIG. 4 may be associated with at least one of the operations of FIG. 3.

Referring to FIG. 4, in the state 401 corresponding to an unfolded state, the electronic device 101 may display a video included in media content in a flexible display 150. While displaying the video, the electronic device 101 may execute a function for outputting audio channels included in the media content through a plurality of speakers (e.g., a first speaker 161 to a fourth speaker 164). According to an embodiment, the electronic device 101 may determine mapping between a plurality of audio channels and the plurality of speakers based on an orientation of the video displayed in the flexible display 150. In the state 401 outputting the video based on a direction illustrated in FIG. 4, the electronic device 101 may match a left channel of audio channels for stereo to a first speaker 161 and/or a third speaker 163 positioned at a first housing 111, and match a right channel of the audio channels to a second speaker 162 and/or a fourth speaker 164 positioned in a third housing 113. In the state 401, similar to displaying a video through the entire flexible display 150, the electronic device 101 may output each of audio channels corresponding to the video using all of the plurality of speakers.

Referring to FIG. 4, in the state 401 displaying the video in a flat portion of the flexible display 150 formed on the first housing 111, a second housing 112, and the third housing 113, the electronic device 101 may control all of the plurality of speakers by associating with each of the audio channels with the plurality of speakers to play audio corresponding to the video based on stereo. In the state 401 of FIG. 4, the electronic device 101 may identify rotation of a first hinge assembly 121 and/or a second hinge assembly 122. By the rotation, at least a portion of the flexible display 150 may be bent.

Referring to FIG. 4, the state 402 that a second angle 142 between the second housing 112 and the third housing 113 is reduced by the rotation of the second hinge assembly 122 is illustrated. According to an embodiment, the electronic device 101 may switch from the state 401 to the state 402 based on identifying the second angle 142 reduced to an angle range (e.g., an angle range between approximately 30° and approximately 175° including a right angle 90°) smaller than a straight angle based on a sensor (e.g., the sensor 230 of FIG. 2). For example, the electronic device 101 may compare a preset angle range (e.g., an angle range including a straight angle) 180° to a first angle 141 and/or the second angle 142 corresponding to a state that a flat surface is formed by two housings connected through a hinge assembly. Based on the comparison, the electronic device 101 may identify folding in the first hinge assembly 121 and/or the second hinge assembly 122. Based on the comparison, the electronic device 101 may identify a speaker corresponding to each of the audio channels among the plurality of speakers.

In the state 402 of FIG. 4, the electronic device 101 identifying that the first angle 141 is included in a first angle range including the straight angle and the second angle 142 is included in a second angle range smaller than the first angle range may determine that a state of the electronic device 101 is a sub-folded state folded by the second angle 142 in the second angle range. The electronic device 101 identifying that the second angle 142 is reduced may identify a motion by which the flexible display 150 is folded based on the second hinge assembly 122. In a state displaying a video in the flexible display 150, the electronic device 101 identifying the motion by which the flexible display 150 is folded based on one of the first hinge assembly 121 and/or the second hinge assembly 122 may display the video in one of flat portions of the flexible display 150 distinguished by a hinge assembly folded by the motion.

Referring to FIG. 4, in the state 402, the electronic device 101 may identify flat portions 421 and 422 of the flexible display 150 distinguished by the second hinge assembly 122 based on identifying the second angle 142 in the second angle range including a right angle. The portion 421 may be a portion of the flexible display 150 on the first housing 111 and the second housing 112 connected along the first angle 141 in the first angle range associated with the straight angle. The portion 422 may be a portion of the flexible display 150 on the third housing 113 distinguished by a second folding axis 132 of the folded second hinge assembly 122. The electronic device 101 may identify any one portion in which a video is to be displayed, based on directions of the portions 421 and 422.

According to an embodiment, the electronic device 101 may identify at least one of the directions of the portions 421 and 422 and/or a posture, a shape, and/or a direction of the electronic device 101 based on an IMU (e.g., the IMU 234 of FIG. 2). For example, the electronic device 101 may identify a direction of gravity applied to at least one of the first housing 111 to the third housing 113 using the IMU. Based on at least one of the direction, the first angle 141, or the second angle 142, the electronic device 101 may identify at least one of the directions (e.g., directions of normal lines of the portions 421 and 422) of the portions 421 and 422.

Referring to FIG. 4, in the state 402 identifying a direction of gravity facing a direction of a-z axis, it is assumed that the portion 421 of the flexible display 150 on the first housing 111 and the second housing 112 is perpendicular to the direction of the gravity, and the portion 422 of the flexible display 150 on the third housing 113 is not perpendicular to the direction of the gravity. The electronic device 101 identifying the assumed direction of the gravity may display a video in the portion 422 that is not perpendicular to the direction of the gravity, among the portions 421 and 422.

In an embodiment, in the state 402 playing the video using the portion 422, the electronic device 101 may, based on a size, a direction, and/or an aspect ratio of the portion 422, determine a size and/or a direction of the video displayed in the portion 422. Based on the assumption, in the state 402 in which the third housing 113 is erected, a lower end of the video displayed through the portion 422 may correspond to an edge of the third housing 113 connected to the second hinge assembly 122.

In the state 402 of FIG. 4, the electronic device 101 may adjust mapping between audio channels and speakers corresponding to the video based on the video displayed in the portion 422. Based on the direction of the video displayed in the portion 422, the electronic device 101 may map a left channel of the audio channels to the first speaker 161 and the second speaker 162, and map a right channel of the audio channels to the third speaker 163 and the fourth speaker 164. Based on the mapping, audio corresponding to the left channel may be outputted through the first speaker 161 and/or the second speaker 162, and audio corresponding to the right channel may be outputted through the third speaker 163 and/or the fourth speaker 164.

In the state 402 of FIG. 4, the electronic device 101 may display a screen (e.g., a home screen including a list of applications) distinguished from the video in the portion 421 different from the portion 422 in which the video is displayed. By displaying the screen distinguished from the video in the portion 421, the electronic device 101 may support multi-tasking (or multi-window) based on the flat portions 421 and 422 of the flexible display 150 distinguished by the second hinge assembly 122. In the state 402, the electronic device 101 may support execution of another software application installed in the electronic device 101 by using the portion 421 together with the video displayed through the portion 422.

According to an embodiment, the electronic device 101 may execute a function for individually controlling speakers corresponding to each of the portions 421 and 422 in the state 402 supporting the multi-tasking using the portions 421 and 422 distinguished by the flexible display 150 being folded. In the state 402 of FIG. 4, in order to control the first speaker 161 and the third speaker 163 positioned in the first housing 111 associated with the portion 421 independently from another speaker (the second speaker 162 and the fourth speaker 164 positioned in the third housing 113 corresponding to the portion 422), the electronic device 101 may display a visual object 430 in the portion 421. The visual object 430 including an icon and/or an image representing mute is exemplarily illustrated, but an embodiment is not limited thereto.

In an embodiment, in response to identifying an input (e.g., a touch input tapping a portion of the flexible display 150 in which the visual object 430 is displayed and/or clicking on the visual object 430) indicating selection of the visual object 430, the electronic device 101 may set volumes of the first speaker 161 and the third speaker 163 to substantially zero, or may release mapping between video-related audio channels and the first speaker 161 and the third speaker 163. Based on the input, the electronic device 101 may at least temporarily cease playing audio corresponding to the video through the first speaker 161 and the third speaker 163. After receiving the input, the electronic device 101 may maintain playing the audio through the second speaker 162 and the fourth speaker 164. After identifying the input associated with the visual object 430, the electronic device 101 may display an icon and/or an image for resuming playing the audio through the first speaker 161 and the third speaker 163. The icon and/or the image may be displayed based on a location of the flexible display 150 in which the visual object 430 was displayed.

In an embodiment, in the state 402 that the video is displayed through the portion 422 and the audio corresponding to the video is played using all of the speakers, the electronic device 101 may release the mapping between the first speaker 161 and the third speaker 163 and the audio based on a software application executed through the portion 421. For example, based on identifying an input for executing an software application (e.g., a music application) for playing other audio distinguished from the audio through the portion 421, the electronic device 101 may play the other audio using the first speaker 161 and the third speaker 163. While the software application is being executed, audio corresponding to the video displayed through the portion 422 may be played through the second speaker 162 and the fourth speaker 164, and the other audio provided from the software application may be playing through the first speaker 161 and the third speaker 163.

As described above, according to an embodiment, the electronic device 101 may, based on directions of the gravity applied to each of the flat portions 421 and 422 of the flexible display 150, determine a location in which a video is to be displayed among the portions 421 and 422 and/or mapping between audio channels and speakers associated with the video. In case that a specific portion (e.g., the portion 421 facing in a direction parallel to a direction of the gravity based on the assumption) is perpendicular to the direction of the gravity, the electronic device 101 may display the video in another portion (e.g., according to the assumption, the portion 422) different from the specific portion.

Hereinafter, referring to FIG. 5, an operation of the electronic device 101 that controls the speakers according to a posture, a shape, and/or a direction of the electronic device 101 based on a plurality of folding axes (e.g., a first folding axis 131 and a second folding axis 132) will be exemplarily described.

FIG. 5 illustrates an example of an operation of an electronic device 101 according to deformation in folding axes according to an embodiment of the disclosure. The electronic device 101 of FIGS. 1A, 1B and/or 2 and/or the processor 210 of FIG. 2 may perform an operation described with reference to FIG. 5.

Referring to FIG. 5, different states 501, 502, and 503 of the first electronic device 101-1 of FIG. 1A are illustrated. Although an operation of the first electronic device 101-1 is described, the second electronic device 101-2 of FIG. 1B may also perform the operation of the first electronic device 101-1 described with reference to FIG. 5. In the state 501 corresponding to an unfolded state, the first electronic device 101-1 may display a video in an entire substantially flat flexible display 150, based on identifying a first angle 141 and a second angle 142 in an angle range including a straight angle similar to the state 401 of FIG. 4. In the state 501, the first electronic device 101-1 may, based on a direction of a video displayed in the flexible display 150, correspond a plurality of speakers (e.g., a first speaker 161 to a fourth speaker 164) to each of audio channels corresponding to the video. For example, based on identifying the first angle 141 and the second angle 142 included in a preset angle range including the straight angle, the first electronic device 101-1 may distribute or allocate each of audio channels for stereo to the plurality of speakers based on the direction of the video displayed in the flexible display 150.

Referring to FIG. 5, in the state 501 displaying the video in the flexible display 150, the first electronic device 101-1 may identify a motion by which the flexible display 150 is folded based on one of a first hinge assembly 121 or a second hinge assembly 122, based on one or more sensors (e.g., the sensor 230 of FIG. 2). The first electronic device 101-1 identifying the motion may display the video in a portion having a relatively large size (or extent) among flat portions of the flexible display 150 distinguished by a hinge assembly folded by the motion.

Referring to FIG. 5, in the state 502 that a second housing 112 and a third housing 113 are folded based on the second hinge assembly 122, the first electronic device 101-1 may identify folding of the second housing 112 and the third housing 113 based on a sensor corresponding to the second hinge assembly 122. The first electronic device 101-1 identifying folding of the second housing 112 and the third housing 113 may identify flat portions 521 and 522 of the flexible display 150 distinguished by the folded second hinge assembly 122. In an embodiment of the first electronic device 101-1 including a plurality of folding axes (e.g., a first folding axis 131 and a second folding axis 132), since the plurality of folding axes are spaced apart from a central axis of the first electronic device 101-1 and/or the flexible display 150, a size, a shape, and/or an extent of the portions 521 and 522 of the flexible display 150 distinguished by a folded folding axis may be different from each other. In the state 502 of FIG. 5, the first electronic device 101-1 identifying the flat portions 521 and 522 of the flexible display 150 distinguished by the second hinge assembly 122 folded along the second angle 142 smaller than the straight angle may display a video in the portion 521 larger than the portion 522. For example, in the state 502, the first electronic device 101-1 may display the video in the portion 521 of the flexible display 150 positioned on a first housing 111 and the second housing 112.

In the state 502 of FIG. 5, the first electronic device 101-1 displaying the video in the portion 521 may output audio associated with the video through a speaker included in the first housing 111 corresponding to the portion 521 among the first housing 111 to the third housing 113. For example, the first electronic device 101-1 may control the first speaker 161 and/or the third speaker 163 to output the audio associated with the video among the first speaker 161 to the fourth speaker 164. The first electronic device 101-1 may map audio channels associated with the video to each of the first speaker 161 and the third speaker 163. For example, the first electronic device 101-1 in the state 502 may associate a left channel of the audio channels with the first speaker 161, and a right channel of the audio channels with the third speaker 163. Based on the example, the first electronic device 101-1 may control the first speaker 161 based on the left channel and control the third speaker 163 based on the right channel. An embodiment is not limited thereto, and the first electronic device 101-1 may output audio matched through the first speaker 161 and the third speaker 163 based on a mono channel. In the state 502 controlling selectively the first speaker 161 and the third speaker 163, the first electronic device 101-1 may refrain from controlling the second speaker 162 and the fourth speaker 164 positioned in the third housing 113 from the portion 521 in which the video is displayed.

Referring to FIG. 5, in the state 503 that both the first hinge assembly 121 and the second hinge assembly 122 are folded, the first electronic device 101-1 may identify portions 531, 532, and 533 of the flexible display 150 distinguished by the first folding axis 131 and the second folding axis 132 having the first angle 141 and the second angle 142 smaller than the straight angle. The first electronic device 101-1 may display a video on the portion 532 corresponding to the second housing 112 located at a center among the portions 531, 532, and 533.

In the state 503 of FIG. 5, as both the first angle 141 and the second angle 142 are reduced to smaller than the straight angle, the flexible display 150 may have a concave shape. Based on the concave shape, a range (or angle) at which the flexible display 150 is visible may be reduced than a range in the unfolded state (e.g., the state 501). The state 503 including the flexible display 150 having the concave shape may be referred to as a privacy state. In the state 503 corresponding to the privacy state, the first electronic device 101-1 may reduce a volume of speakers to lower than a preset volume. For example, the first electronic device 101-1 may adjust volumes of the first speaker 161 to the fourth speaker 164 to substantially zero. For example, the first electronic device 101-1 may deactivate or mute the first speaker 161 to the fourth speaker. For example, the first electronic device 101-1 may deactivate the first speaker 161 to the fourth speaker 164 by adjusting a voltage of a power signal provided to the first speaker 161 to the fourth speaker 164 to lower than a preset voltage.

Referring to FIG. 5, in the state 501 corresponding to the unfolded state, the first electronic device 101-1 may switch to the state 502, based on a first motion folding the second hinge assembly 122. In the state 502, the first electronic device 101-1 may display the video in the portion 521 having a relatively large size among the flat portions 521 and 522 of the flexible display 150 distinguished by the second hinge assembly 122 folded by the first motion. In the state 502 displaying the video in the portion 521, the first electronic device 101-1 may output the audio through speakers (e.g., the first speaker 161 and/or the third speaker 163) corresponding to the portion 521. While displaying the video in the portion 521 based on the first motion, the first electronic device 101-1 may switch from the state 502 to the state 503, based on a second motion folding the first hinge assembly 121. In the switched state 503 based on the second motion, the first electronic device 101-1 may display a video in the portion 532 of the flexible display 150 corresponding to the second housing 112 and control all of the speakers to the volume lower than the preset volume.

Although an operation of the first electronic device 101-1 while gradual transitioning from the state 501 to the state 503 has been exemplarily described, an embodiment is not limited thereto. In the state 503 that both the first angle 141 and the second angle 142 are smaller than the straight angle, the first electronic device 101-1 may switch to any one state of the states 501 and 502 based on a motion by which at least one of the first hinge assembly 121 and/or the second hinge assembly 122 is unfolded. For example, in the state 503, based on identifying the first angle 141 increased to the straight angle by rotation of the first hinge assembly 121, the first electronic device 101-1 may display the video in the portion 521 based on the state 502 and output audio corresponding to the video through the first speaker 161 and the third speaker 163. For example, in a case of being switched to the unfolded state by rotation of both the first hinge assembly 121 and the second hinge assembly 122, the first electronic device 101-1 may display the video in the entire flexible display 150 and map audio channels corresponding to the video to all of the first speaker 161 to fourth speaker 164.

As described above, according to an embodiment, the first electronic device 101-1 may dynamically control the plurality of speakers, based on a posture and/or a shape of the first electronic device 101-1 that is folded by the plurality of folding axes. According to the shape, the first electronic device 101-1 may change a relationship between the plurality of speakers and audio channels corresponding to a video, based on a location in the flexible display 150 in which the video is played. Based on the posture and/or the shape of the first electronic device 101-1, the first electronic device 101-1 may improve a user experience associated with playback of media content, which is a combination of the video and/or the audio channels, by changing the location in the flexible display 150 in which the video is played and/or volumes of each of the plurality of speakers.

In an embodiment, in case that the number of the flat portions of the flexible display 150 is two or more (e.g., the states 502 and 503 of FIG. 5), the electronic device 101 may execute a function for changing a location of a video displayed through any one of the portions. Based on the function, while changing the location of the video, the electronic device 101 may change mapping between the plurality of speakers and/or the audio channels corresponding to the video. Hereinafter, an operation of the electronic device 101 that controls speakers based on the location of the video in the flexible display 150 will be described with reference to FIGS. 6A and 6B.

FIGS. 6A and 6B illustrate an example of an operation of an electronic device 101 displaying a video in at least one of portions of a flexible display 150 distinguished by folding axes according to various embodiments of the disclosure. The electronic device 101 of FIGS. 1A, 1B and/or 2 and/or the processor 210 of FIG. 2 may perform the operation described with reference to FIGS. 6A and 6B.

Referring to FIG. 6A, a sub-folded state of the electronic device 101 folded along a second folding axis 132 among a first folding axis 131 and the second folding axis 132 formed by a plurality of hinge assemblies is illustrated. Although an operation of the electronic device 101 folded along the second folding axis 132 is described with reference to FIG. 6A, an embodiment is not limited thereto, and for example, in the sub-folded state folded along the first folding axis 131, the electronic device 101 may perform the operation described with reference to FIG. 6A.

In a state 601 of FIG. 6A, similar to the state 502 of FIG. 5, the electronic device 101 may display a video in a relatively large size of flat portions 611 and 612 of the flexible display 150 distinguished by a folded second hinge assembly 122. In the state 601, the electronic device 101 may output audio corresponding to the video through a first speaker 161 and a third speaker 163 corresponding to the portion 611 of speakers (e.g., the first speaker 161 to a fourth speaker 164).

According to an embodiment, the electronic device 101 may, in the state 601 in which the flexible display 150 is distinguished by the second hinge assembly 122, display a visual object 615 to move the video to another portion 612 of the flexible display 150 distinguished by the second hinge assembly 122 at a portion 611 of the flexible display 150 in which the video is displayed. An embodiment is not limited thereto, and the electronic device 101 may display the visual object 615 at the portion 612 different from the portion 611 in which the video is displayed. Although the visual object 615 having a shape of a button including a preset text, such as “transition,” is exemplarily illustrated, an embodiment is not limited thereto.

In the state 601 of FIG. 6A, the electronic device 101 may change a location in the flexible display 150 in which the video is displayed from the portion 611 to the portion 612 in response to an input indicating selection of the visual object 615. For example, the electronic device 101 receiving the input may switch from the state 601 to a state 602. In the state 602, the electronic device 101 may display the visual object 615 to move the location of the flexible display 150 in which the video is displayed to the portion 611 while displaying the video through the portion 612 of the flexible display 150.

Referring to FIG. 6A, in the state 602 displaying the video in the portion 612, the electronic device 101 may output audio corresponding to the video through speakers (e.g., the second speaker 162 and/or the fourth speaker 164) included in the third housing 113 corresponding to the portion 612 among speakers. For example, the electronic device 101 switched from the state 601 to the state 602 may associated an audio channel outputted through the first speaker 161 in the state 601 with the second speaker 162, and associated an audio channel outputted through the third speaker 163 in the state 601 with the fourth speaker 164. In the example, the electronic device 101 may cease controlling the first speaker 161 and the third speaker 163 and control the second speaker 162 and the fourth speaker 164 as it is switched from the state 601 to the state 602.

Referring to FIG. 6B, a sub-folded state of a first electronic device 101-1 in which all of folding axes formed by a plurality of hinge assemblies are folded is illustrated. While both a first angle 141 and a second angle 142 have a second angle range smaller than a first angle range including a straight angle, the first electronic device 101-1 may display a video in any one portion of portions 631, 632, and 633 of the flexible display 150 distinguished by a first hinge assembly 121 and the second hinge assembly 122. In a state 603, similar to the state 503 of FIG. 5, the first electronic device 101-1 may display a video in the portion 632 of the flexible display 150 corresponding to a second housing 112. In the state 603, the first electronic device 101-1 may refrain from outputting the audio corresponding to the video, by deactivating a plurality of speakers.

In the state 603 of FIG. 6B, the first electronic device 101-1 may display a visual object (e.g., visual objects 634 or 635) for changing a location of a video displayed in the portion 632. Although the visual objects 634 and 635 having a shape of an arrow are exemplarily illustrated, a shape and/or a location of the visual object for changing the location of the video is not limited thereto. The first electronic device 101-1 may display a preset text (e.g., “move”) for guiding movement of the video together with the visual objects 634 and 635. In the state 603, based on an input indicating selection of the visual object 634 including an arrow facing the portion 631, the first electronic device 101-1 may switch to a state 604. In the state 603, based on an input indicating selection of the visual object 635 including an arrow facing the portion 633, the first electronic device 101-1 may switch to a state 605.

Referring to FIG. 6B, in the switched state 604 based on an input associated with the visual object 634, the first electronic device 101-1 may display a video on the portion 631. Together with the video displayed on the portion 631, the first electronic device 101-1 may display a visual object 641 for movement of the video. Based on an input indicating selection of the visual object 641 including an arrow facing other portions 632 and 633 different from the portion 631, the first electronic device 101-1 may switch to the state 603. In the state 604 displaying the video based on the portion 631, the first electronic device 101-1 may output audio corresponding to the video through speakers (e.g., the first speaker 161 and/or the third speaker 163) in the first housing 111 corresponding to the portion 631. An embodiment is not limited thereto, and the first electronic device 101-1 may maintain a cessation of output of the audio.

Referring to FIG. 6B, in the switched state 605 based on an input associated with the visual object 635, the first electronic device 101-1 may display a video on the portion 633. Together with the video displayed on the portion 633, the first electronic device 101-1 may display a visual object 651 for movement of the video. Based on an input indicating selection of the visual object 651 including an arrow facing other portions 631 and 632 different from the portion 633, the first electronic device 101-1 may switch to the state 603. In the state 605 displaying the video based on the portion 633, the first electronic device 101-1 may output audio corresponding to the video through speakers (e.g., the second speaker 162 and/or the fourth speaker 164) in the third housing 113 corresponding to the portion 633. An embodiment is not limited thereto, and the first electronic device 101-1 may maintain a cessation of output of the audio.

As described above, according to an embodiment, the electronic device 101 may switch a location at which a video is displayed between the portions 611, 612, 631, 632, and 633 of the flexible display 150 folded by a plurality of folding axes. Together with the switch of the position, the electronic device 101 may change at least one speaker in which audio corresponding to the video is to be displayed among the plurality of speakers.

In an embodiment, the electronic device 101 may simultaneously display a plurality of videos through different surfaces of a housing. While simultaneously displaying the plurality of videos, the electronic device 101 may simultaneously output audio corresponding to the plurality of videos using the plurality of speakers. Hereinafter, an operation of the electronic device 101 for simultaneously outputting the audio corresponding to the plurality of videos will be described with reference to FIGS. 7A and 7B.

FIGS. 7A and 7B illustrate an example of an operation of an electronic device 101 displaying videos in portions of a flexible display 150 distinguished by folding axes according to various embodiments of the disclosure. The electronic device 101 of FIGS. 1A, 1B and/or 2 and/or the processor 210 of FIG. 2 may perform the operation described with reference to FIGS. 7A and 7B.

Referring to FIG. 7A, a state 701 of a first electronic device 101-1 including both a cover display 152 and a flexible display 150 is illustrated. It is assumed that in the state 701 associated with a sub-folded state, the flexible display 150 is folded at a right angle along a first hinge assembly 121 and a first housing 111 is erected. According to an embodiment, the first electronic device 101-1 may identify gravity applied in a-z axis direction by using sensor data of an IMU (e.g., the IMU 234 of FIG. 2) in the state 701. Based on the sensor data of the IMU, the first electronic device 101-1 may identify a posture, a shape, and/or a direction of the first electronic device 101-1 in which the first housing 111 is erected.

In the state 701 of FIG. 7A, the first electronic device 101-1 may output a plurality of videos through each of the cover display 152 and the flexible display 150. A first video may be displayed in the cover display 152, and the first electronic device 101-1 may display a second video in a portion 711 of the flexible display 150 formed on a surface of the first housing 111 in which the cover display 152 is positioned, among portions 711 and 712 of the flexible display 150 distinguished by the folded first hinge assembly 121. In the state 701 that the first housing 111 is erected, the first electronic device 101-1 may display the plurality of videos through the portion 711 of the flexible display 150 and the cover display 152 positioned in both surfaces of the first housing 111.

Referring to FIG. 7A, in the state 701 displaying the plurality of videos through each of the portion 711 of the flexible display 150 and the cover display 152, the first electronic device 101-1 may determine a relationship between the plurality of videos and a plurality of speakers based on the posture, the shape, and/or the direction of the first electronic device 101-1. In the state 701 of FIG. 7A, the first electronic device 101-1 may output audio corresponding to the first video displayed through the cover display 152 using a first speaker 161 and/or a third speaker 163 positioned in the first housing 111. For example, a left channel of audio channels corresponding to the first video may be associated with the first speaker 161, and a right channel of the audio channels corresponding to the first video may be associated with the third speaker 163. The first electronic device 101-1 may output audio corresponding to the second video displayed through the portion 711 of the flexible display 150 through another speaker (e.g., a second speaker 162 and/or a fourth speaker 164) different from the first speaker 161 and the third speaker 163 corresponding to the first video. For example, the left channel of audio channels corresponding to the second video may be associated with the fourth speaker 164, and the right channel of the audio channels corresponding to the second video may be associated with the second speaker 162.

In an embodiment, in the state 701 displaying the second video through the portion 711 of the flexible display 150, the first electronic device 101-1 may support multi-tasking through the other portion 712 of the flexible display 150. Through the portion 712, the first electronic device 101-1 may display a screen (e.g., a home screen) including a list of applications installed in the first electronic device 101-1.

Referring to FIG. 7A, according to an embodiment, the first electronic device 101-1 may identify an external electronic device 242 using communication circuitry (e.g., the communication circuitry 240 of FIG. 2). Referring to FIG. 7A, the external electronic device 242 including earbuds 242-1 and 242-2 that may be attached to a left ear and a right ear of a user is exemplarily illustrated. An embodiment is not limited thereto. For example, the first electronic device 101-1 may identify a location of the external electronic device 242 with respect to the first electronic device 101-1 using a first wireless signal associated with an ultra-wide band (UWB) based on identifying the external electronic device 242 for an output of the audio channel. Based on the identified location, the first electronic device 101-1 may transmit audio corresponding to any one of the plurality of videos to the external electronic device 242. The first electronic device 101-1 may cease outputting the audio transmitted to the external electronic device 242 through a speaker of the first electronic device 101-1.

For example, based on identifying the location of the external electronic device 242 adjacent to the cover display 152 among the cover display 152 and the flexible display 150 (e.g., the portion 711 of the flexible display 150), the first electronic device 101-1 may transmit at least one of the audio channels of the first video displayed through the cover display 152 to the external electronic device 242. While transmitting at least one of the audio channels of the first video to the external electronic device 242, the first electronic device 101-1 may cease outputting the audio channels of the first video through speakers (e.g., the first speaker 161 and/or the third speaker 163). For example, the first electronic device 101-1 may refrain from controlling the first speaker 161 and the third speaker 163 of the first housing 111 in which the cover display 152 is positioned while transmitting a wireless signal associated with the audio channels of the first video to the external electronic device 242.

For example, the first electronic device 101-1 identifying the external electronic device 242 located in a direction in which the portion 711 of the flexible display 150 faces may transmit at least one of the audio channels of the second video displayed through the portion 711 to the external electronic device 242. While transmitting a wireless signal associated with at least one of the audio channels of the second video to the external electronic device 242, the first electronic device 101-1 may at least temporarily cease controlling the speaker of the first electronic device 101-1 based on the audio channels of the second video.

Referring to FIG. 7B, a state 702 of a second electronic device 101-2 displaying videos through different portions 721 and 722 of the flexible display 150 is illustrated. It is assumed that in the state 702 associated with the sub-folded state, the flexible display 150 is folded at an angle greater than a straight angle along the first hinge assembly 121 and is folded at an angle smaller than the straight angle along the second hinge assembly 122. In the state 702, it is assumed that the second electronic device 101-2 identifies gravity applied in a-z direction. For example, in a case that the second electronic device 101-2 is located on the ground by a rear surface of the third housing 113, the second electronic device 101-2 may identify the gravity applied in the −z direction based on the IMU (e.g., the IMU 234 of FIG. 2). In the state 702 of FIG. 7B, the portions 721 and 722 of the flexible display 150 of the second electronic device 101-2 may be positioned toward different directions. A posture and/or a shape of the second electronic device 101-2 illustrated in FIG. 7B may be referred to as a tent posture.

In the state 702 of FIG. 7B, the second electronic device 101-2 may display a plurality of videos through the portions 721 and 722 of the flexible display 150 facing different directions. For example, the second electronic device 101-2 may display the plurality of videos in each of the portions 721 and 722 of the flexible display 150 that are distinguished along the first hinge assembly 121 folded at an angle greater than the straight angle. In the state 702 of FIG. 7B, the second electronic device 101-2 may control the first speaker 161 and the third speaker 163 positioned in the first housing 111 based on the audio channels associated with the first video displayed in the portion 721 of the flexible display 150 corresponding to the first housing 111. For example, the second electronic device 101-2 may control the first speaker 161 based on the left channel of the audio channels and the third speaker 163 based on the right channel of the audio channels. In the state 702 of FIG. 7B, the second electronic device 101-2 may control the second speaker 162 and the fourth speaker 164 positioned in the third housing 113 based on the audio channels corresponding to the second video displayed through the portion 722. For example, the second electronic device 101-2 may control the second speaker 162 based on the right channel of the audio channels of the second video, and the fourth speaker 164 based on the left channel of the audio channels of the second video.

Referring to FIG. 7B, according to an embodiment, the second electronic device 101-2 may provide audio corresponding to any one of videos displayed through the portions 721 and 722 to the external electronic device 242 based on a direction of the external electronic device 242 with respect to the second electronic device 101-2, based on identifying the external electronic device 242 for outputting an audio channel. The direction of the external electronic device 242 with respect to the second electronic device 101-2 may be identified based on a wireless signal associated with the UWB.

For example, the second electronic device 101-2 identifying the external electronic device 242 located in the direction in which the portion 721 faces may transmit at least one of the audio channels corresponding to the first video displayed through the portion 721 to the external electronic device 242. In the example, the second electronic device 101-2 may at least temporarily cease controlling the first speaker 161 and/or the third speaker 163, based on the audio channels corresponding to the first video. For example, the second electronic device 101-2 identifying the external electronic device 242 located in the direction in which the portion 722 faces may transmit at least one of the audio channels corresponding to the second video displayed through the portion 722 to the external electronic device 242. While transmitting at least one of the audio channels corresponding to the second video to the external electronic device 242, the second electronic device 101-2 may refrain from controlling the second speaker 162 and/or the fourth speaker 164 based on the audio channels corresponding to the second video.

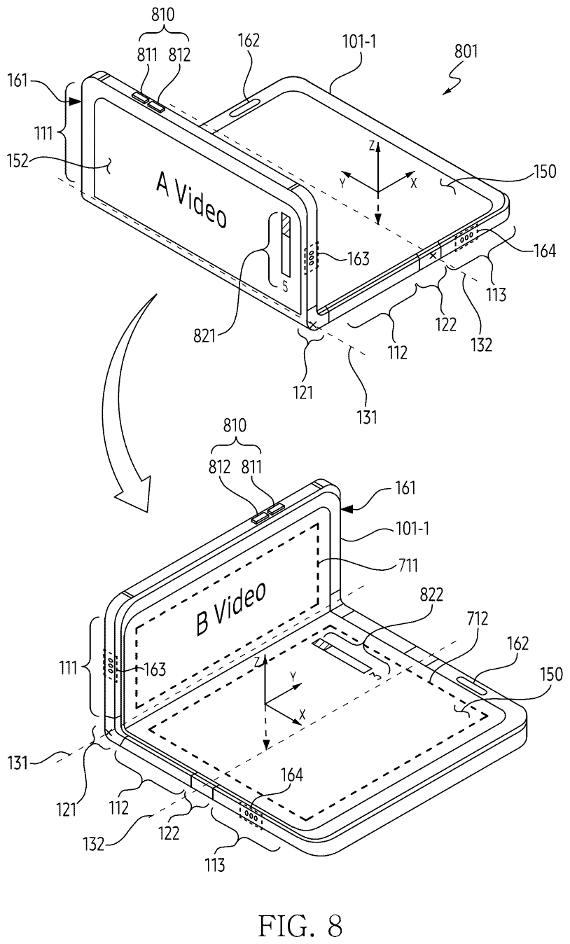

FIG. 8 illustrates an example of an operation of an electronic device 101 displaying visual objects for adjusting volumes corresponding to videos according to an embodiment of the disclosure. The electronic device 101 of FIGS. 1A, 1B and/or 2 and/or the processor 210 of FIG. 2 may perform an operation described with reference to FIG. 8.

Referring to FIG. 8, a state 801 of a first electronic device 101-1 of FIG. 1A is illustrated. Referring to FIG. 8, in a sub-folded state folded along a first hinge assembly 121 folded at a right angle, the electronic device 101 may display a first video in a cover display 152 positioned on a surface of a first housing 111 and a second video on a portion 711 of the flexible display 150 positioned on another surface of the first housing 111 opposite to the surface. The state 801 of FIG. 8 may correspond to the state 701 of FIG. 7A.

Referring to FIG. 8, according to an embodiment, the electronic device 101 may include buttons 810 formed on a lateral surface connecting a front surface and a rear surface. The buttons 810 may be referred to as a switch and/or a physical key. Based on the buttons 810 mapped to different functions, the electronic device 101 may identify an input for executing at least one of the functions. Referring to FIG. 8, it is assumed that a first button 811 corresponds to a function of gradually increasing volumes of speakers (e.g., a first speaker 161 to a fourth speaker 164) of the electronic device 101, and a second button 812 corresponds to a function of gradually reducing the volumes.

In the state 801 displaying a plurality of videos of FIG. 8, according to an embodiment, the electronic device 101 may change the volumes of the speakers in response to an input of pressing at least one of the buttons 810. In response to the input, the electronic device 101 may display visual objects 821 and 822 for adjusting volumes corresponding to each of videos displayed through the cover display 152 and the flexible display 150 to each of the cover display 152 and the flexible display 150. In the state 801 of FIG. 8, the electronic device 101 may display, in the cover display 152, the visual object 821 for adjusting volumes of the audio channels corresponding to the first video displayed through the cover display 152. The electronic device 101 may display, in the flexible display 150, the visual object 822 for adjusting volumes of the audio channels corresponding to the second video displayed through the portion 711 of the flexible display 150. A location, a shape, and/or a size of each of the visual objects 821 and 822 displayed in the cover display 152 and the flexible display 150 are not limited to an embodiment of FIG. 8.

Referring to FIG. 8, in the state 801 that the visual objects 821 and 822 having a shape of a slide bar are displayed, the electronic device 101 may receive an input for adjusting at least one of the volumes of the audio channels associated with the videos displayed in the cover display 152 and the flexible display 150. For example, based on the input pressing at least one of the buttons 810, the electronic device 101 may change volumes associated with all of the videos. In the example, the electronic device 101 may visualize a change in the volumes by changing a display of the visual objects 821 and 822.

For example, based on a touch input (e.g., a drag input) associated with the visual object 821, the electronic device 101 may change a volume for playing the audio channels of the first video corresponding to the visual object 821. In the example, the electronic device 101 may change volumes of the first speaker 161 and a third speaker 163 among the plurality of speakers. In the example, the electronic device 101 may change the display of the visual object 821 among the visual objects 821 and 822, based on the touch input.

For example, based on a touch input (e.g., the drag input) associated with the visual object 822, the electronic device 101 may change a volume for playing the audio channels of the second video corresponding to the visual object 822. In the example, the electronic device 101 may change the volumes of a second speaker 162 and the fourth speaker 164 among the plurality of speakers. In the example, the electronic device 101 may change the display of the visual object 822 among the visual objects 821 and 822, based on the touch input.

As described above, according to an embodiment, in a state (e.g., the state 801) displaying a plurality of videos, the electronic device 101 may display visual objects (e.g., the visual objects 821 and 822) for individually adjusting volumes of the plurality of videos. Based on the visual objects, the electronic device 101 may receive or identify a touch input for individually adjusting the volumes.

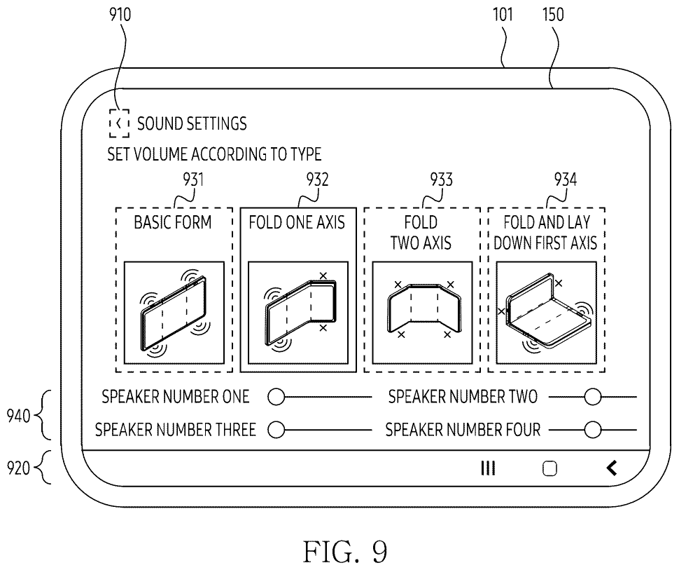

FIG. 9 illustrates an example of an operation of an electronic 101 device obtaining information for controlling speakers in each of different states of the electronic device 101 distinguished by deformation in folding axes according to an embodiment of the disclosure. The electronic device 101 of FIGS. 1A, 1B and/or 2 and/or the processor 210 of FIG. 2 may perform an operation described with reference to FIG. 9.

Referring to FIG. 9, according to an embodiment, the electronic device 101 may display a screen for obtaining preset information to be used to control speakers in different postures and/or states (e.g., an unfolded state and/or a sub-folded state) of the electronic device 101. Referring to a screen of FIG. 9, the electronic device 101 may display a visual object 910 for switching to another screen different from the screen and/or a navigation bar 920 for searching for screens displayed through a flexible display 150.

In the screen of FIG. 9, the electronic device 101 may display a list of the postures of the electronic device 101 corresponding to the preset information, using visual objects 931, 932, 933, and 934 including images. The visual object 931 may include an image representing the unfolded state. The visual object 932 may include an image representing a state that one folding axis of a plurality of folding axes is folded in the sub-folded state. The visual object 933 may include an image representing the sub-folded state that all of the plurality of folding axes are folded. The visual object 934 may include an image representing the sub-folded state that a housing of the electronic device 101 folded by the folding axis is erected, such as a tent state. A posture, a shape, and/or a direction of the electronic device 101 corresponding to the preset information are not limited to a posture represented by the images included in the visual objects 931, 932, 933, and 934.

Referring to FIG. 9, based on an input indicating selection of the visual object 932, the electronic device 101 may display visual objects for receiving the preset information corresponding to a posture, a shape, and/or a direction indicated by the visual object 932 in a region 940. Referring to FIG. 9, in the region 940, the electronic device 101 may display visual objects in a shape of a slider bar for adjusting volumes of each of the speakers (e.g., the first speaker 161 to the fourth speaker 164 of FIGS. 1A and 1B) included in the electronic device 101. Shapes and/or locations of the visual objects displayed to adjust the volumes are not limited to an example of FIG. 9. In addition to the slider bar, a visual object such as a progress bar and/or a picker may be displayed to adjust the volumes of the speakers. Based on the visual objects having a shape of the slider bar, the electronic device 101 may identify a user input for adjusting the volumes of each of the speakers. Based on the user input, the electronic device 101 may obtain the preset information. The preset information obtained in a state of FIG. 9 may be used to adjust the volumes of the plurality of speakers while having the posture, the shape, and/or the direction represented by the image of the visual object 932.

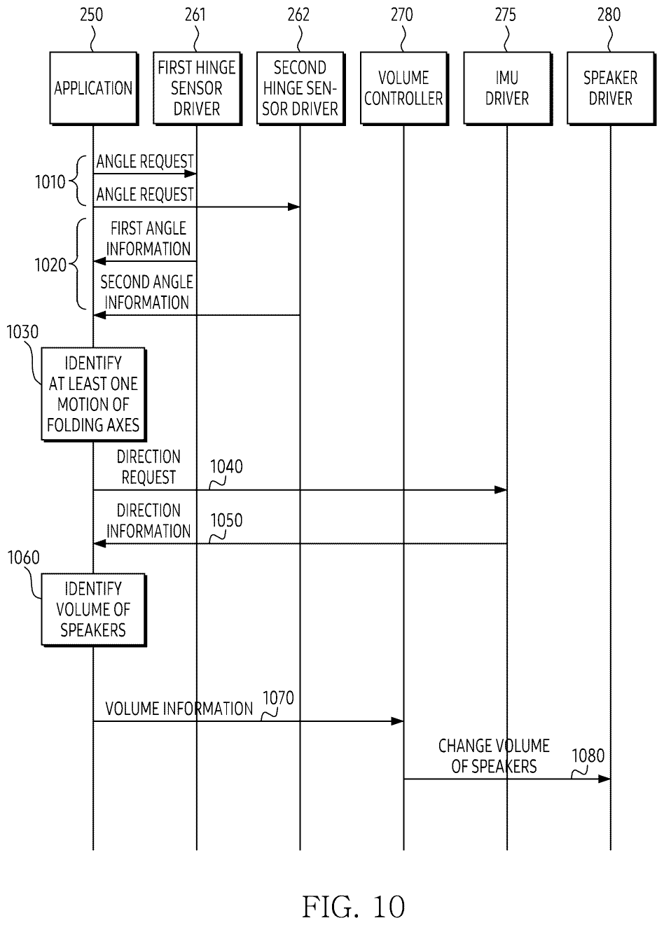

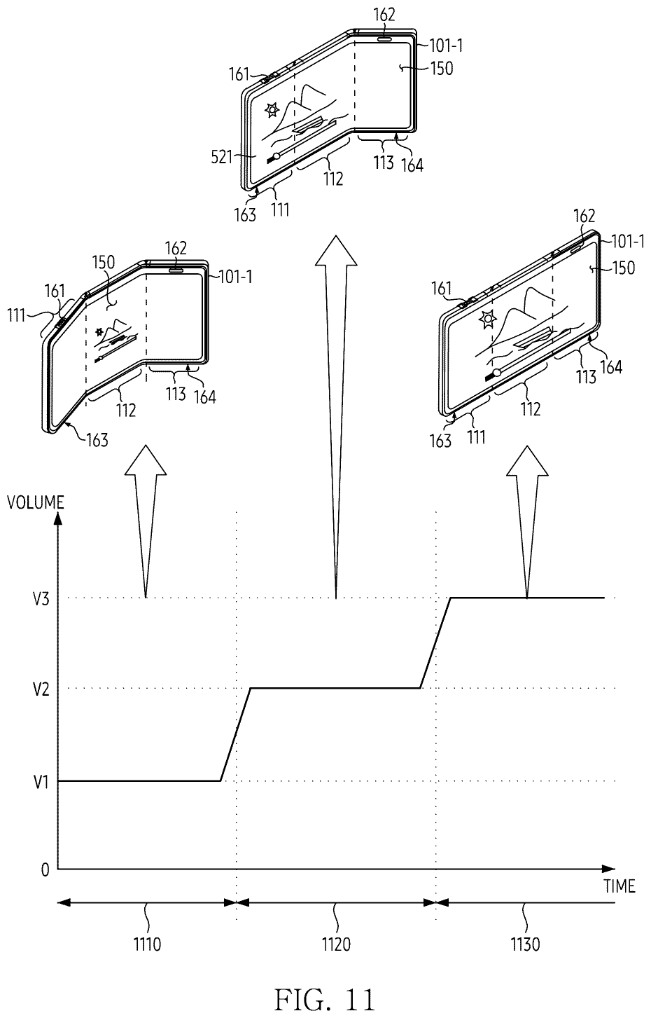

In an embodiment, a distance between the speakers positioned in the electronic device 101 may be changed by folding at least one of hinge assemblies. Hereinafter, an embodiment of an electronic device 101 adjusting the volumes for the speakers based on a change in a distance between the speakers will be described with reference to FIGS. 10 and 11.

FIG. 10 illustrates a flowchart of an operation of an electronic device distinguished by software applications according to an embodiment of the disclosure. An operation of the electronic device described with reference to FIG. 10 may be performed by the electronic device 101 of FIGS. 1A, 1B and 2 and/or the processor 210 of FIG. 2.

In the following embodiment, each operation may be sequentially performed, but is not necessarily performed sequentially. For example, an order of each operation may be changed, and at least two operations may be performed in parallel.

Referring to FIG. 10, an operation of a processor performed based on execution of an application 250 is described. The operation of FIG. 10 may be performed by the processor executing the application 250 for playing media content including a video and/or audio. While displaying the video, the processor may perform at least one of the operations of FIG. 10. At least one of the operations of FIG. 10 may be performed similarly to the operation of the electronic device described with reference to FIG. 3.

Referring to FIG. 10, in an operation 1010, the processor may execute a function for obtaining an angle using hinge sensor drivers (e.g., a first hinge sensor driver 261 and/or a second hinge sensor driver 262), based on the execution of the application 250. The operation 1010 of FIG. 10 may be performed identically or similarly to the operation 310 of FIG. 3.

Referring to FIG. 10, in an operation 1020, the processor may provide angle information identified using each of hinge sensors for the execution of the application 250 based on execution of the first hinge sensor driver 261 and the second hinge sensor driver 262. Obtaining the angle information by the processor based on the operation 1020 may be repeatedly (or periodically) performed based on the execution of the first hinge sensor driver 261 and the second hinge sensor driver 262. The operation 1020 of FIG. 10 may be performed identically or similarly to the operation 320 of FIG. 3.

Referring to FIG. 10, in an operation 1030, the processor may identify at least one motion of folding axes (e.g., the first folding axis 131 and the second folding axis 132 of FIGS. 1A and 1B) of the electronic device using first angle information identified based on the first hinge sensor driver 261 and/or second angle information identified based on the second hinge sensor driver 262. The motion may include a motion that is folded based on at least one of hinge assemblies (e.g., the first hinge assembly 121 and the second hinge assembly 122 of FIGS. 1A and 1B) corresponding to each of the folding axes. The operation 1030 of FIG. 10 may be performed identically or similarly to the operation 330 of FIG. 3.

Referring to FIG. 10, in an operation 1040, based on identifying the at least one motion of the folding axes, the processor may execute a function for requesting a direction of the electronic device with an IMU driver 275. Based on the request, the processor may execute the function for obtaining the direction of the electronic device using the IMU driver 275. The operation 1040 of FIG. 10 may be performed identically or similarly to the operation 340 of FIG. 3. Referring to FIG. 10, in an operation 1050, the processor may provide direction information on the direction of the electronic device for the execution of the application 250 based on execution of the IMU driver 275. Obtaining the direction information by the processor based on the operation 1050 may be performed identically or similarly to the operation 350 of FIG. 3.

Referring to FIG. 10, in an operation 1060, the processor may identify volumes of speakers by using at least one of the first angle information, the second angle information, or the direction information. For example, the processor may identify the volumes of the speakers based on a distance between the speakers indicated by the first angle information and the second angle information. The processor may increase or decrease the volumes proportionally to the distance.

Referring to FIG. 10, in an operation 1070, the processor may execute a volume controller 270 based on the volumes of the speakers identified based on the operation 1060. In a state that the volume controller 270 is executed, the processor may change volumes of a plurality of speakers to the volumes identified based on the operation 1060 with a speaker driver 280 based on an operation 1080.

Hereinafter, an operation of the electronic device that controls the speakers according to the volumes identified based on the operation 1060 of FIG. 10 will be described with reference to FIG. 11.

FIG. 11 illustrates a graph for describing an operation of an electronic device 101 adjusting a volume based on angles of folding axes according to an embodiment of the disclosure. The electronic device 101 of FIGS. 1A, 1B and/or 2 and/or the processor 210 of FIG. 2 may perform an operation described with reference to FIG. 11. An operation of a first electronic device 101-1 described with reference to FIG. 11 may be related to at least one of the operations of FIG. 3 and/or the operations of FIG. 10. Although the operation of the first electronic device 101-1 is described with reference to FIG. 11, the second electronic device 101-2 of FIG. 1B may also perform the operation described with reference to FIG. 11.

Referring to FIG. 11, a graph indicating a volume of audio outputted by the first electronic device 101-1 while changing from a sub-folded state (or a folded state) to an unfolded state is illustrated. The first electronic device 101-1 may identify a distance between a first speaker 161 of a first housing 111 and a second speaker 162 of a third housing 113 based on a sum of angles identified in hinge assemblies. The sum of the angles may be substantially 0° in a case that the first electronic device 101-1 is in a folded state. The sum of the angles may increase from 0° to 360° as the first electronic device 101-1 is switched from the folded state to the unfolded state. In a time period 1110 in which audio is outputted based on a first volume V1, the first volume V1 may correspond to the distance between the first speaker 161 and the second speaker 162 identified based on the hinge assemblies folded below a straight angle. In the time period 1110, the first volume V1 may correspond to a size of a portion (e.g., a portion of a flexible display 150 positioned on a second housing 112) of the flexible display 150 in which a video is displayed.

Referring to FIG. 11, in a time period 1120 after the time period 1110, an angle between the first housing 111 and the second housing 112 may substantially correspond to a straight angle, and an angle between the second housing 112 and the third housing 113 may be folded to smaller than the straight angle. Since the distance between the first speaker 161 and the second speaker 162 is increased based on the angles in the time period 1120, the first electronic device 101-1 may change a volume from the first volume V1 to a second volume V2 greater than the first volume V1. The second volume V2 of the time period 1120 may correspond to a size of a portion (e.g., a portion of the flexible display 150 positioned on the first housing 111 and the second housing 112) of the flexible display 150 in which a video is displayed.

Referring to FIG. 11, in a time period 1130 after the time period 1120, the first electronic device 101-1 may have a posture corresponding to the unfolded state. In the time period 1130, the distance between the first speaker 161 and the second speaker 162 may be maximized. Based on the maximized distance, the first electronic device 101-1 may change the volume of the audio to a third volume V3 greater than the second volume V2. The third volume V3 of the time period 1130 may correspond to a size (e.g., an entire active region and/or display region of the flexible display 150) of the video in the flexible display 150.

As described above, according to an embodiment, the electronic device 101 may change a volume of audio and/or an audio channel, based on a distance between speakers. For example, the volume may increase or decrease in proportion to the distance. An embodiment is not limited thereto, and a function such as a trigonometric function and/or a step function may be used to calculate the volume from the distance. The distance between the speakers may be identified based on an angle of folding axes included in the electronic device 101.

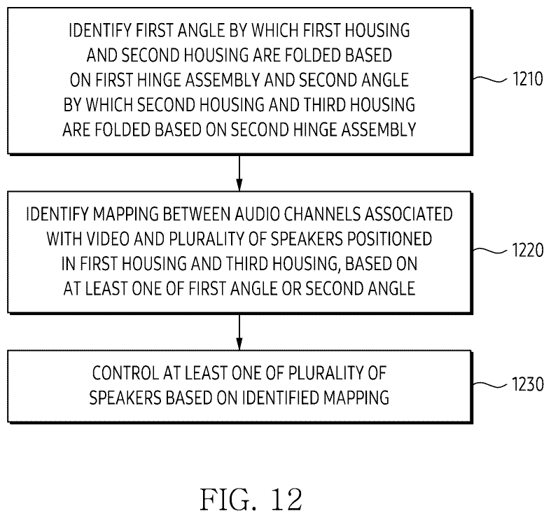

FIG. 12 illustrates an example of a flowchart of an electronic device according to an embodiment of the disclosure. The electronic device 101 of FIGS. 1A, 1B and/or 2 and/or the processor 210 of FIG. 2 may perform an operation described with reference to FIG. 12.

In the following embodiment, each operation may be sequentially performed, but is not necessarily performed sequentially. For example, an order of each operation may be changed, and at least two operations may be performed in parallel.

Referring to FIG. 12, in an operation 1210, according to an embodiment, a processor of the electronic device may identify a first angle by which a first housing and a second housing are folded based on a first hinge assembly and a second angle by which the second housing and a third housing are folded based on a second hinge assembly. The first angle of the operation 1210 may include the first angle 141 of FIGS. 1A and 1B. The second angle of the operation 1210 may include the second angle 142 of FIGS. 1A and 1B. The processor may identify the first angle and/or the second angle of the operation 1210 based on sensor data of sensors corresponding to each of the first hinge assembly and the second hinge assembly. The processor may perform at least one of operations of FIG. 12 based on execution of an application for outputting audio.

Referring to FIG. 12, in an operation 1220, according to an embodiment, the processor of the electronic device may identify mapping between audio channels associated with a video and a plurality of speakers positioned in the first housing and the third housing, based on at least one of the first angle or the second angle. The plurality of speakers of the operation 1220 may include the first speaker 161 to the fourth speaker 164 of FIGS. 1A and 1B. For example, the processor may identify the mapping between the audio channels and the plurality of speakers based on the operation described with reference to FIGS. 1A, 1B, 2 to 5, 6A, 6B, 7A, 7B, and 9 to 11. The mapping may include information indicating at least one speaker corresponding to each of the audio channels or at least one of volumes of the plurality of speakers. In the operation 1220, the processor may identify the mapping between the audio channels and the plurality of speakers based on a direction of the electronic device identified using an IMU (e.g., the IMU 234 of FIG. 2) as well as the first angle and/or the second angle.

Referring to FIG. 12, in an operation 1230, according to an embodiment, the processor of the electronic device may control at least one of the plurality of speakers based on the identified mapping. The processor may individually activate or deactivate the plurality of speakers by controlling switches for providing a power signal to each of the plurality of speakers. Using the mapping identified based on the operation 1220, the processor may individually control each of the plurality of speakers. Using the mapping identified based on the operation 1220, the processor may individually change the volumes of the plurality of speakers.

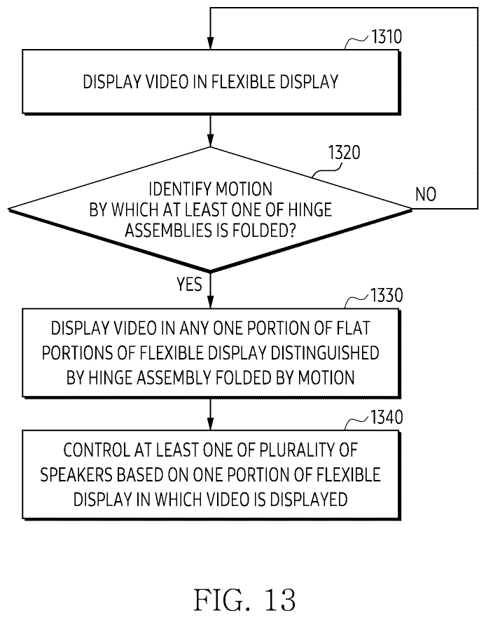

FIG. 13 illustrates an example of a flowchart of an electronic device according to an embodiment of the disclosure. The electronic device 101 of FIGS. 1A, 1B and/or 2 and/or the processor 210 of FIG. 2 may perform an operation described with reference to FIG. 13. At least one of operations of FIG. 13 may be associated with at least one of operations of FIG. 12.

In the following embodiment, each operation may be sequentially performed, but is not necessarily performed sequentially. For example, an order of each operation may be changed, and at least two operations may be performed in parallel.

Referring to FIG. 13, in an operation 1310, according to an embodiment, a processor of the electronic device may display a video in a flexible display. The operation 1310 may be performed based on an application (e.g., the application 250 of FIG. 2) executed by the processor.

Referring to FIG. 13, in an operation 1320, according to an embodiment, the processor of the electronic device may identify a motion by which at least one of hinge assemblies is folded. The hinge assemblies of the operation 1320 may include the first hinge assembly 121 and/or the second hinge assembly 122 of FIGS. 1A and 1B. The operation 1320 of FIG. 13 may be performed identically or similarly to the operation 1210 of FIG. 12. Prior to identifying the motion of the operation 1320 (1320—NO), the processor may maintain displaying the video based on the operation 1310. In a state identifying the motion of the operation 1320 (1320—YES), the processor may perform an operation 1330.

Referring to FIG. 13, in an operation 1330, according to an embodiment, the processor of the electronic device may display the video in any one portion of flat portions of the flexible display distinguished by a hinge assembly folded by the motion. By the hinge assembly folded by the motion of the operation 1320, the flexible display may be distinguished by a plurality of flat portions. The portions of the operation 1330 may include the portions 421, and 422 of FIG. 4, the portions 521, 522, 531, 532, and 533 of FIG. 5, the portions 611 and 612 of FIG. 6A, the portions 631, 632, and 633 of FIG. 6B, the portions 711 and 712 of FIG. 7A, the portions 721, 722, and 723 of FIG. 7B, and/or the portions 711 and 712 of FIG. 8. In a state displaying the video based on the operation 1330, the processor may display an icon and/or a button for moving the video in the portions, such as the visual objects 615, 634, 635, 641, and 651 of FIGS. 6A and 6B.

Referring to FIG. 13, in an operation 1340, according to an embodiment, the processor of the electronic device may control at least one of a plurality of speakers based on a portion of the flexible display in which the video is displayed. In the operation 1340, the processor may identify, among the speakers of the electronic device, at least one speaker corresponding to the portion of the flexible display in which the video is displayed. Using the identified at least one speaker, the processor may output audio corresponding to the video of the operation 1310. While controlling the at least one speaker, the processor may refrain from controlling other speakers among the plurality of speakers. In a case of controlling the plurality of speakers based on the operation 1340, the processor may allocate each of audio channels corresponding to the video to the plurality of speakers. The processor allocating the audio channels to the plurality of speakers may be performed based on a posture, a shape, and/or a direction of the electronic device folded by the hinge assemblies.

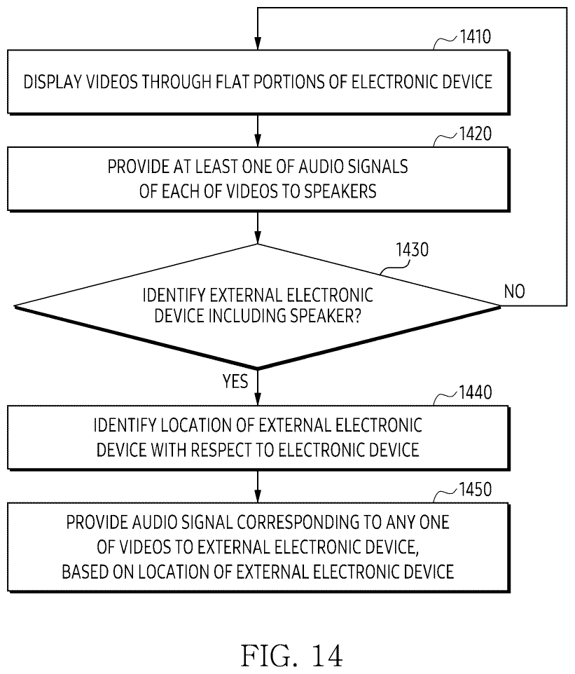

FIG. 14 illustrates an example of a flowchart of an electronic device according to an embodiment of the disclosure. The electronic device 101 of FIGS. 1A, 1B and/or 2 and/or the processor 210 of FIG. 2 may perform an operation described with reference to FIG. 14. At least one of operations of FIG. 14 may be associated with at least one of operations of FIGS. 12 and 13. At least one of the operations of FIG. 14 may be associated with the operation of the first electronic device 101-1 to the second electronic device 101-2 described with reference to FIGS. 7A and 7B.

In the following embodiment, each operation may be sequentially performed, but is not necessarily performed sequentially. For example, an order of each operation may be changed, and at least two operations may be performed in parallel.

Referring to FIG. 14, in an operation 1410, according to an embodiment, a processor of the electronic device may display videos through flat portions of the electronic device. For example, the processor may independently display the videos through a first portion in which a cover display (e.g., the cover display 152 of FIG. 1A) is positioned and a second portion in which the flexible display (e.g., the flexible display 150 of FIG. 1A) is positioned.

Referring to FIG. 14, in an operation 1420, according to an embodiment, the processor of the electronic device may provide at least one of audio signals of each of the videos to speakers. The speakers of the operation 1420 may include the first speaker 161 to the fourth speaker 164 of FIGS. 1A, 1B, and 2. The audio signals of the operation 1420 may correspond to each of the audio channels corresponding to the video. The processor may determine mapping between the speakers and the videos, based on locations in the electronic device in which the videos are displayed. Based on the mapping, the processor may provide an audio signal corresponding to a first video to a speaker adjacent to the first portion of the electronic device in which the first video is displayed, and provide an audio signal corresponding to a second video to a speaker adjacent to a second portion of the electronic device in which the second video is displayed.

Referring to FIG. 14, in an operation 1430, according to an embodiment, the processor of the electronic device may identify an external electronic device including a speaker. The external electronic device of the operation 1430 may include the external electronic device 242 of FIG. 2. The processor may identify the external electronic device paired with the electronic device, using communication circuitry (e.g., the communication circuitry 240 of FIG. 2). In a state identifying the external electronic device such as a wireless earphone for providing audio (1430—YES), the processor may perform an operation 1440. Prior to identifying the external electronic device (1430—NO), the processor may output the audio signals corresponding to the videos using the speakers based on the operations 1410 and 1420.

Referring to FIG. 14, in an operation 1440, according to an embodiment, the processor of the electronic device may identify a location of the external electronic device with respect to the electronic device. The processor may identify the location of the external electronic device, using a wireless signal based on a UWB. For example, the processor may receive the wireless signal for identifying the location of the external electronic device through UWB antennas spaced apart from each other. The processor may identify the location of the operation 1440, using a phase difference identified in the UWB antennas receiving the wireless signal. The location of the operation 1440 may include a relative location and/or direction of the external electronic device with respect to the electronic device.

Referring to FIG. 14, in an operation 1450, according to an embodiment, the processor of the electronic device may provide the audio signal corresponding to any one of the videos to the external electronic device, based on the location of the external electronic device. For example, the electronic device may transmit the audio signal corresponding to the video displayed in any one of the portions of the operation 1410 adjacent to the external electronic device to the external electronic device. While transmitting the audio signal to the external electronic device, the processor may cease controlling the speaker using the audio signal transmitted to the external electronic device.

As described above, according to an embodiment, the electronic device may adjust a relationship between the audio channels and the speakers based on folding of folding axes. Based on the relationship, as the electronic device includes a plurality of folding axes, the audio to be outputted through each of the speakers may be adjusted based on a positional relationship between the speakers deformed between different postures and the location of the video in the flexible display.

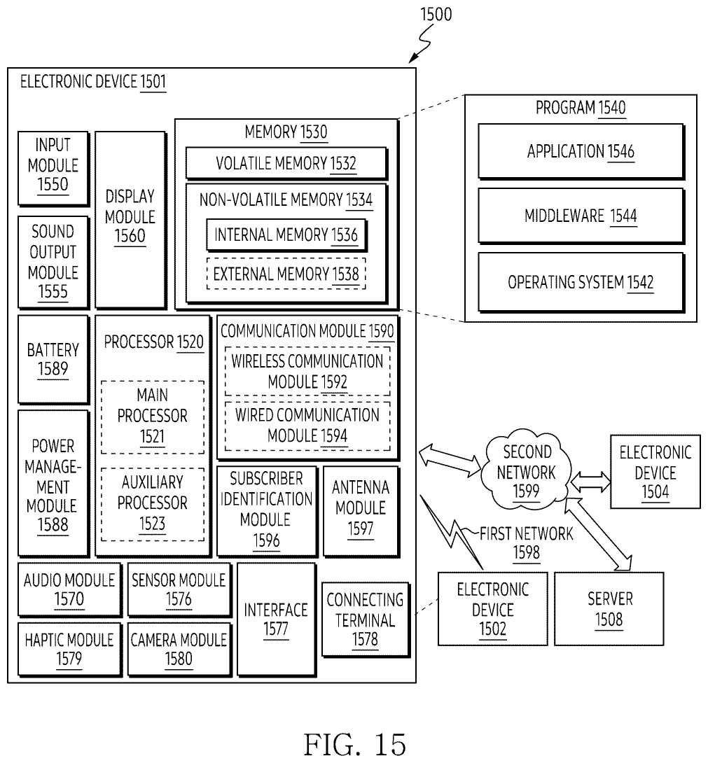

FIG. 15 is a block diagram illustrating an electronic device 1501 in a network environment 1500 according to an embodiment of the disclosure. Referring to FIG. 15, the electronic device 1501 in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module (SIM) 1596, or an antenna module 1597. In some embodiments, at least one of the components (e.g., the connecting terminal 1578) may be omitted from the electronic device 1501, or one or more other components may be added in the electronic device 1501. In some embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to an embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to an embodiment, the connecting terminal 1578 may include, for example, an HDMI connector, a USB connector, an SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to an embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the millimeter wave (mmWave) band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 1564 dB or less) for implementing mMTC, or U-plane latency (e.g., 0.5 ms or less for each of downlink (DL) and uplink (UL), or a round trip of 15 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element composed of a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502 or 1504 or server 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In another embodiment, the external electronic device 1504 may include an internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

In an embodiment, a method of changing audio channels outputted through speakers based on a posture of an electronic device and/or a flexible display may be required. As described above, according to an embodiment, the electronic device (e.g., the electronic device 101 of FIGS. 1A, 1B, 2 to 5, 6A, 6B, 7A, 7B, 8, and 9) may comprise a first housing (e.g., the first housing 111 of FIGS. 1A, 1B, 2 to 5, 6A, 6B, 7A, 7B, and 8 to 11), a first speaker (e.g., the first speaker 161 of FIGS. 1A, 1B, 2 to 5, 6A, 6B, 7A, 7B, and 8 to 11) positioned at the first housing, a second housing (e.g., the second housing 112 of FIGS. 1A, 1B, 2 to 5, 6A, 6B, 7A, 7B, and 8 to 11), a first hinge assembly (e.g., the first hinge assembly 121 of FIGS. 1A, 1B, 2 to 5, 6A, 6B, 7A, 7B, and 8) for rotatably connecting the first housing and the second housing, a third housing (e.g., the third housing 113 of FIGS. 1A, 1B, 2 to 5, 6A, 6B, 7A, 7B, and 8 to 11), a second speaker (e.g., the second speaker 162 of FIGS. 1A, 1B, 2 to 5, 6A, 6B, 7A, 7B, and 8 to 11) positioned at the third housing, a second hinge assembly (e.g., the second hinge assembly 122 of FIGS. 1A, 1B, 2 to 5, 6A, 6B, 7A, 7B, and 8) for rotatably connecting the second housing and the third housing, the flexible display (e.g., the flexible display 150 of FIGS. 1A, 1B, 2 to 5, 6A, 6B, 7A, 7B, and to 11) disposed from the first housing to the third housing crossing the first hinge assembly, the second housing and the second hinge assembly, one or more sensors (e.g., the sensor 230 of FIG. 2), and memory (e.g., the memory 215 of FIG. 2) storing executable instructions, and at least one processor (e.g., the processor 210 of FIG. 2) executing the instructions by accessing the memory. The at least one processor may be configured to, in a state displaying a video in the flexible display, identify, by using the one or more sensors, a first angle (e.g., the first angle 141 of FIGS. 1A, 1B, 2 to 5, 6A, and 6B) by which the first housing and the second housing are folded based on the first hinge assembly and a second angle (e.g., the second angle 142 of FIGS. 1A, 1B, 2 to 5, 6A, and 6B) by which the second housing and the third housing are folded based on the second hinge assembly. The at least one processor may be configured to, based on at least one of the identified first angle and the second angle, control the first speaker to output the audio channel corresponding to the first speaker, and control the second speaker to output the audio channel corresponding to the second speaker.

For example, the at least one processor may be configured to identify, based on at least one of the first angle or the second angle, speakers respectively corresponding to audio channels associated with the video from among the first speaker and the second speaker.

For example, the at least one processor may be configured to control, based on identifying an audio channel corresponding to the first speaker among the audio channels, the speaker to output the audio channel corresponding to the first speaker.

For example, the at least one processor may be configured to control, based on identifying an audio channel corresponding to the second speaker among the audio channels, the second speaker to output the audio channel corresponding to the second speaker.

As described above, according to an embodiment, an electronic device (e.g., the electronic device 101 of FIGS. 1A, 1B, 2 to 5, 6A, 6B, 7A, 7B, 8, and 9) may comprise a first housing (e.g., the first housing 111 of FIGS. 1A, 1B, 2 to 5, 6A, 6B, 7A, 7B, and 8 to 11), a first speaker (e.g., the first speaker 161 of FIGS. 1A, 1B, 2 to 5, 6A, 6B, 7A, 7B, and to 11) positioned at the first housing, a second housing (e.g., the second housing 112 of FIGS. 1A, 1B, 2 to 5, 6A, 6B, 7A, 7B, and to 11), a first hinge assembly (e.g., the first hinge assembly 121 of FIGS. 1A, 1B, 2 to 5, 6A, 6B, 7A, 7B, and 8) for rotatably connecting the first housing and the second housing, a third housing (e.g., the third housing 113 of FIGS. 1A, 1B, 2 to 5, 6A, 6B, 7A, 7B, and to 11), a second speaker (e.g., the second speaker 162 of FIGS. 1A, 1B, 2 to 5, 6A, 6B, 7A, 7B, and to 11) positioned at the third housing, a second hinge assembly (e.g., the second hinge assembly 122 of FIGS. 1A, 1B, 2 to 5, 6A, 6B, 7A, 7B, and 8) for rotatably connecting the second housing and the third housing, a flexible display (e.g., the flexible display 150 of FIGS. 1A, 1B, 2 to 5, 6A, 6B, 7A, 7B, and to 11) disposed from the first housing to the third housing crossing the first hinge assembly, the second housing and the second hinge assembly, one or more sensors (e.g., the sensor 230 of FIG. 2), and a processor (e.g., the processor 210 of FIG. 2). The processor may be configured to, in a state displaying a video in the flexible display, identify, by using the one or more sensors, a first angle (e.g., the first angle 141 of FIGS. 1A, 1B, 2 to 5, 6A, and 6B) by which the first housing and the second housing are folded based on the first hinge assembly and a second angle (e.g., the second angle 142 of FIGS. 1A, 1B, 2 to 5, 6A, and 6B) by which the second housing and the third housing are folded based on the second hinge assembly. The processor may be configured to identify, based on at least one of the first angle or the second angle, speakers respectively corresponding to audio channels associated with the video from among the first speaker and the second speaker. The processor may be configured to control, based on identifying an audio channel corresponding to the first speaker among the audio channels, the speaker to output the audio channel corresponding to the first speaker. The processor may be configured to control, based on identifying an audio channel corresponding to the second speaker among the audio channels, the second speaker to output the audio channel corresponding to the second speaker. According to an embodiment, the electronic device may, based on an angle between the housings, adjust a relationship between audio channels and speakers.

For example, the processor may be configured to identify, by comparing a preset angle range corresponding to a state that a flat surface is formed by housings connected through a hinge assembly to the first angle or the second angle, speakers respectively corresponding to the audio channels from among the first speaker or the second speaker.

For example, the processor may be configured to, based on identifying the first angle and the second angle included in the preset angle range, allocate, based on a direction of the video displayed in the flexible display, one audio channel among the audio channels for stereo to the first speaker, and allocate another audio channel among the audio channels to the second speaker.

For example, the processor may be configured to, based on identifying the first angle included in the preset angle range and the second angle smaller than the preset angle range, refrain from controlling the second speaker using at least one of the audio channels.

For example, the processor may be configured to display the video in a portion of the flexible display positioned on the first housing and the second housing from among portions of the flexible display distinguished by the second hinge assembly folded by an angle smaller than the preset angle range.

For example, the processor may be configured to display, at a first portion (e.g., the first portion 611 of FIG. 6A) of the flexible display in which the video is displayed, a visual object (e.g., the visual object 615) to move the video to a second portion (e.g., the second portion 612 of FIG. 6A) of the flexible display distinguished by the second hinge assembly. The processor may be configured to change, in response to an input indicating to select the visual object, a location in the flexible display in which the video is displayed from the first portion to the second portion. The processor may be configured to control the second speaker by associating an audio channel among the audio channels that was outputted through the first speaker with the second speaker among the first speaker or the second speaker.

For example, the processor may be configured to control, based on identifying the first angle and the second angle smaller than the preset angle range, the first speaker and the second speaker using a volume lower than a preset volume.

For example, the electronic device may include a cover display (e.g., the cover display 152 of FIG. 1A) positioned on a second surface of the first housing opposite to a first surface of the first housing in which a portion of the flexible display is positioned. The processor may be configured to, in a state displaying a first video in the flexible display and displaying a second video in the cover display, display, based on identifying the first angle reduced to be smaller than the preset angle range, the first video at a portion corresponding to the first housing among portions of the flexible display distinguished by the first hinge assembly folded by the first angle. The processor may be configured to control the first speaker to output at least one of audio channels corresponding to the second video. The processor may be configured to control the second speaker to output at least one of audio channels corresponding to the first video.

For example, the electronic device may include a third speaker (e.g., the third speaker 163 in FIGS. 1A, 1B, 2 to 5, 6A, 6B, 7A, 7B, and to 11) positioned at a second edge of the first housing opposite to a first edge of the first housing where the first speaker is positioned, and a fourth speaker (the fourth speaker 164 in FIGS. 1A1B, 2 to 5, 6A, 6B, 7A, 7B, and 8 to 11) positioned at a fourth edge of the third housing opposite to a third edge of the third housing where the second speaker is positioned. The processor may be configured to control the first speaker and the third speaker by associating the first speaker and the third speaker with each of the audio channels corresponding to the first video. The processor may be configured to control the second speaker and the fourth speaker by associating the second speaker and the fourth speaker to each of the audio channels corresponding with the second video.

For example, the electronic device may include communication circuitry (e.g., the communication circuitry 240 of FIG. 2). The processor may be configured to identify, based on identifying an external electronic device (e.g., the external electronic device 242 of FIG. 2) for outputting an audio channel, a location of the external electronic device with respect to the electronic device using a first wireless signal associated with an ultra-wide band (UWB). The processor may be configured to transmit, based on identifying the location of the external electronic device adjacent to the cover display among the cover display and the flexible display, a second wireless signal for transmitting at least one of audio channels corresponding to the second video to the external electronic device using the communication circuitry. The processor may be configured to refrain from controlling the first speaker while the second wireless signal is being transmitted.

For example, the processor may be configured to, in response to an input associated with a preset button (e.g., the buttons 810 of FIG. 8), display a first visual object to adjust a volume of the audio channels corresponding to the first video in the flexible display, and display a second visual object to adjust a volume of the audio channels corresponding to the second video in the cover display.

As described above, according to an embodiment, a method of an electronic device may comprise identifying (e.g., the operation 1210 of FIG. 12), in a state displaying a video in a flexible display of the electronic device, by using one or more sensors of the electronic device, a first angle by which a first housing and a second housing of the electronic device are folded based on a first hinge assembly, and a second angle by which the second housing and a third housing of the electronic device are folded based on a second hinge assembly. The method may comprise identifying (e.g., the operation 1220 of FIG. 12), based on at least one of the first angle or the second angle, speakers respectively corresponding to audio channels associated with the video from among a first speaker positioned at the first housing or a second speaker positioned at the third housing. The method may comprise controlling, based on identifying an audio channel corresponding to the first speaker among the audio channels, the first speaker to output the audio channel corresponding to the first speaker. The method may comprise controlling, based on identifying an audio channel corresponding to the second speaker among the audio channels, the second speaker to output the audio channel corresponding to the second speaker.

For example, the identifying the speakers respectively corresponding to the audio channels may comprise identifying, by comparing a preset angle range associated with a state that a portion of the flexible display positioned on two housings connected through a hinge assembly is flat to the first angle or the second angle, speakers respectively corresponding to the audio channels from among the first speaker or the second speaker.

For example, the identifying the speakers respectively corresponding to the audio channels may comprise, based on identifying the first angle and the second angle included in the preset angle range, allocating, based on a direction of the video displayed in the flexible display, one audio channel among the audio channels for stereo to the first speaker, and allocating another audio channel among the audio channels to the second speaker.

For example, the method may comprise, based on identifying the first angle included in the preset angle range and the second angle smaller than the preset angle range, refraining from controlling the second speaker using at least one of the audio channels.

For example, the refraining may comprise displaying the video in a portion of the flexible display positioned on the first housing and the second housing from among portions of the flexible display distinguished by the second hinge assembly folded by an angle smaller than the preset angle range.

For example, the refraining may comprise displaying, at a first portion of the flexible display in which the video is displayed, a visual object to move the video to a second portion of the flexible display distinguished by the second hinge assembly. The method may comprise changing, in response to an input indicating to select the visual object, a location in the flexible display in which the video is displayed from the first portion to the second portion. The method may comprise controlling the second speaker by associating an audio channel among the audio channels that was outputted through the first speaker with the second speaker among the first speaker or the second speaker.

For example, the method may comprise controlling, based on identifying the first angle and the second angle smaller than the preset angle range, the first speaker and the second speaker using a volume lower than a preset volume.

For example, the method may comprise displaying a first video in the flexible display and displaying a second video in a cover display positioned on a second surface of the first housing opposite to a first surface of the first housing in which the flexible display is positioned. The method may comprise, in a state displaying the first video and the second video, displaying, based on identifying the first angle reduced to be smaller than the preset angle range, the first video at a portion corresponding to the first housing among portions of the flexible display distinguished by the first hinge assembly folded by the first angle. The method may comprise controlling the first speaker to output at least one of audio channels corresponding to the second video. The method may further comprise controlling the second speaker to output at least one of audio channels corresponding to the first video.

As described above, according to an embodiment, an electronic device (e.g., the electronic device 101 of FIGS. 1A, 1B, 2 to 5, 6A, 6B, 7A, 7B, 8, and 9) may comprise a first housing (e.g., the first housing 111 of FIGS. 1A, 1B, 2 to 5, 6A, 6B, 7A, 7B, and 8 to 11), a first speaker (e.g., the first speaker 161 of FIGS. 1A, 1B, 2 to 5, 6A, 6B, 7A, 7B, and 8 to 11) positioned at the first housing, a second housing (e.g., the second housing 112 of FIGS. 1A, 1B, 2 to 5, 6A, 6B, 7A, 7B, and 8 to 11), a first hinge assembly (e.g., the first hinge assembly 121 of FIGS. 1A, 1B, 2 to 5, 6A, 6B, 7A, 7B, and 8) for rotatably connecting the first housing and the second housing, a third housing (e.g., the third housing 113 of FIGS. 1A, 1B, 2 to 5, 6A, 6B, 7A, 7B, and 8 to 11), a second speaker (e.g., the second speaker 162 of FIGS. 1A, 1B, 2 to 5, 6A, 6B, 7A, 7B, and 8 to 11) positioned at the third housing, a second hinge assembly (e.g., the second hinge assembly 122 of FIGS. 1A, 1B, 2 to 5, 6A, 6B, 7A, 7B, and 8) for rotatably connecting the second housing and the third housing, a flexible display (e.g., the flexible display 150 of FIGS. 1A, 1B, 2 to 5, 6A, 6B, 7A, 7B, and 8 to 11) disposed from the first housing to the third housing crossing the first hinge assembly, the second housing and the second hinge assembly, one or more sensors (e.g., the sensor 230 of FIG. 2), and a processor (e.g., the processor 210 of FIG. 2). The processor may be configured to, in a state displaying a video in the flexible display, identify, based on the one or more sensors, a motion by which the flexible display is folded based on one of the first hinge assembly or the second hinge assembly. The processor may be configured to, based on the motion, display the video in a second portion larger than a first portion, among flat portions of the flexible display distinguished by a hinge assembly folded by the motion. The processor may be configured to control one of the first speaker or the second speaker to output audio associated with the video through a speaker included in a housing corresponding to the second portion in which the video is displayed, among the first housing or the third housing.

For example, the processor may be configured to, before identifying the motion, display the video in a flat portion of the flexible display formed on the first housing, the second housing, and the third housing. The processor may be configured to control the first speaker and the second speaker by associating each of audio channels of the audio with the first speaker and the second speaker to play the audio based on stereo.

For example, the processor may be configured to, based on the one or more sensors, identify a second motion by which the flexible display is folded based on another hinge assembly distinguished from the hinge assembly corresponding to a first motion while displaying the video in the second portion based on the motion, which is the first motion. The processor may be configured to, based on the second motion, display the video in a portion of the flexible display corresponding to the second housing, and to control both the first speaker and the second speaker to a volume lower than a preset volume.

For example, the processor may be configured to, based on the one or more sensors, identify directions of gravity applied to the second portion of the flexible display. The processor may be configured to display the video in the first portion of the portions, based on identifying that a direction in which the second portion of the flexible display faces corresponds to a direction of the gravity applied to the second portion.

For example, the processor may be configured to reduce a volume of the audio outputted through at least one of the first speaker or the second speaker, based on identifying that a size of the flexible display in which the video is displayed is reduced by the motion.

As described above, a method of an electronic device may comprise, in a state displaying a video in a flexible display of the electronic device, identifying (e.g., the operation 1320 of FIG. 13), based on one or more sensors of the electronic device, a motion by which the flexible display is folded based on one of a plurality of hinge assemblies of the electronic device. The method may comprise, based on the motion, displaying (e.g., operation 1330 of FIG. 13) the video in a second portion larger than a first portion, among flat portions of the flexible display distinguished by a hinge assembly folded by the motion. The method may comprise controlling (e.g., the operation 1340 of FIG. 13) one of the first speaker or the second speaker to output audio associated with the video through a speaker included in a housing corresponding to the second portion in which the video is displayed, among the first housing or the third housing.

For example, the identifying may comprise, before identifying the motion, displaying the video in a flat portion of the flexible display formed on a first housing, a second housing, and a third housing of the electronic device. The plurality of hinge assemblies may include a first hinge assembly rotatably connecting the first housing and the second housing, and a second hinge assembly rotatably connecting the second housing and the third housing. The identifying may comprise controlling the first speaker and the second speaker by associating each of audio channels of the audio with the first speaker and the second speaker to play the audio based on stereo.

For example, the method may comprise, based on the one or more sensors, identifying a second motion by which the flexible display is folded based on another hinge assembly distinguished from the hinge assembly corresponding to a first motion while displaying the video in the second portion based on the motion, which is the first motion. The method may comprise, based on the second motion, displaying the video in a portion of the flexible display corresponding to the second housing, and controlling both the first speaker and the second speaker to a volume lower than a preset volume.

For example, the method may comprise, based on the one or more sensors, identifying directions of gravity applied to the second portion of the flexible display. The method may comprise displaying the video in the first portion of the portions, based on identifying that a direction in which the second portion of the flexible display faces corresponds to a direction of the gravity applied to the second portion.

For example, the controlling may comprise reducing a volume of the audio outputted through at least one of the first speaker or the second speaker, based on identifying that a size of the flexible display in which the video is displayed is reduced by the motion.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. An electronic device comprising:
a first housing;
a first speaker positioned at the first housing;
a second housing;
a first hinge assembly for rotatably connecting the first housing and the second housing;
a third housing;
a second speaker positioned at the third housing;
a second hinge assembly for rotatably connecting the second housing and the third housing;
a flexible display disposed from the first housing to the third housing crossing the first hinge assembly, the second housing and the second hinge assembly;
one or more sensors;
memory comprising one or more storage media storing instructions; and
at least one processor comprising processing circuitry,
wherein the instructions, when executed by the at least one processor individually or collectively, cause the electronic device to:
in a state displaying a video in the flexible display, identify, by using the one or more sensors, a first angle by which the first housing and the second housing are folded based on the first hinge assembly and a second angle by which the second housing and the third housing are folded based on the second hinge assembly, and
based on at least one of the identified first angle and the second angle, control the first speaker to output a first audio channel corresponding to the first speaker, and control the second speaker to output a second audio channel corresponding to the second speaker.

2. The electronic device of claim 1, wherein the instructions, when executed by the at least one processor individually or collectively, cause the electronic device to:
identify, by comparing a preset angle range corresponding to a state that a flat surface is formed by housings connected through a hinge assembly to the first angle or the second angle, speakers respectively corresponding to the first and second audio channels from among the first speaker or the second speaker.

3. The electronic device of claim 2, wherein the instructions, when executed by the at least one processor individually or collectively, cause the electronic device to:
based on identifying the first angle and the second angle included in the preset angle range, allocate, based on a direction of the video displayed in the flexible display, one audio channel among the audio channels for stereo to the first speaker; and
allocate another audio channel among the audio channels to the second speaker.

4. The electronic device of claim 2, wherein the instructions, when executed by the at least one processor individually or collectively, cause the electronic device to:
based on identifying the first angle included in the preset angle range and the second angle smaller than the preset angle range, refrain from controlling the second speaker using at least one of the first or second audio channels.

5. The electronic device of claim 4, wherein the instructions, when executed by the at least one processor individually or collectively, cause the electronic device to:
display the video in a portion of the flexible display positioned on the first housing and the second housing from among portions of the flexible display distinguished by the second hinge assembly folded by an angle smaller than the preset angle range.

6. The electronic device of claim 5, wherein the instructions, when executed by the at least one processor individually or collectively, cause the electronic device to:
display, at a first portion of the flexible display in which the video is displayed, a visual object to move the video to a second portion of the flexible display distinguished by the second hinge assembly;
change, in response to an input indicating to select the visual object, a location in the flexible display in which the video is displayed from the first portion to the second portion; and
control the second speaker by associating an audio channel among the audio channels that was outputted through the first speaker with the second speaker among the first speaker or the second speaker.

7. The electronic device of claim 2, wherein the instructions, when executed by the at least one processor individually or collectively, cause the electronic device to:
control, based on identifying the first angle and the second angle smaller than the preset angle range, the first speaker and the second speaker using a volume lower than a preset volume.

8. The electronic device of claim 2, further comprising:
a cover display positioned on a second surface of the first housing opposite to a first surface of the first housing at which a portion of the flexible display is positioned,
wherein the instructions, when executed by the at least one processor individually or collectively, cause the electronic device to:
in a state displaying a first video in the flexible display and displaying a second video in the cover display, display, based on identifying the first angle reduced to be lower than the preset angle range, the first video at a portion corresponding to the first housing among portions of the flexible display distinguished by the first hinge assembly folded by the first angle,
control the first speaker to output at least one of audio channels corresponding to the second video, and
control the second speaker to output at least one of audio channels corresponding to the first video.

9. The electronic device of claim 8, further comprising:
a third speaker positioned at a second edge of the first housing opposite to a first edge of the first housing where the first speaker is positioned; and
a fourth speaker positioned at a fourth edge of the third housing opposite to a third edge of the third housing where the second speaker is positioned,
wherein the instructions, when executed by the at least one processor individually or collectively, cause the electronic device to:
control the first speaker and the third speaker by associating the first speaker and the third speaker to each of the audio channels corresponding with the first video, and
control the second speaker and the fourth speaker by associating the second speaker and the fourth speaker to each of the audio channels corresponding with the second video.

10. The electronic device of claim 8, further comprising:
communication circuitry,
wherein the instructions, when executed by the at least one processor individually or collectively, cause the electronic device to:
identify, based on identifying an external electronic device for outputting an audio channel, a location of the external electronic device with respect to the electronic device using a first wireless signal associated with an ultra-wide band (UWB),
transmit, based on identifying the location of the external electronic device adjacent to the cover display among the cover display and the flexible display, a second wireless signal for transmitting at least one of audio channels corresponding to the second video to the external electronic device using the communication circuitry, and
refrain from controlling the first speaker while the second wireless signal is being transmitted.

11. The electronic device of claim 8, wherein the instructions, when executed by the at least one processor individually or collectively, cause the electronic device to:
in response to an input associated with a preset button, display a first visual object to adjust a volume of the audio channels corresponding to the first video in the flexible display; and
display a second visual object to adjust a volume of the audio channels corresponding to the second video in the cover display.

12. The electronic device of claim 1, wherein the instructions, when executed by the at least one processor individually or collectively, cause the electronic device to:
identify, based on at least one of the first angle or the second angle, speakers respectively corresponding to audio channels associated with the video from among the first speaker and the second speaker;
control, based on identifying an audio channel corresponding to the first speaker among the audio channels, the speaker to output the audio channel corresponding to the first speaker; and
control, based on identifying an audio channel corresponding to the second speaker among the audio channels, the second speaker to output the audio channel corresponding to the second speaker.

13. A method performed by an electronic device, the method comprising:
identifying, in a state displaying a video in a flexible display of the electronic device, by using one or more sensors of the electronic device, a first angle by which a first housing and a second housing of the electronic device are folded based on a first hinge assembly, and a second angle by which the second housing and a third housing of the electronic device are folded based on a second hinge assembly;
identifying, based on at least one of the first angle or the second angle, speakers respectively corresponding to audio channels associated with the video from among a first speaker positioned at the first housing or a second speaker positioned at the third housing;
controlling, based on identifying a first audio channel corresponding to the first speaker among the audio channels, the first speaker to output the first audio channel corresponding to the first speaker; and
controlling, based on identifying a second audio channel corresponding to the second speaker among the audio channels, the second speaker to output the second audio channel corresponding to the second speaker.

14. The method of claim 13, wherein the identifying the speakers respectively corresponding to the audio channels comprises:
identifying, by comparing a preset angle range associated with a state that a portion of the flexible display positioned on two housings connected through a hinge assembly is flat to the first angle or the second angle, speakers respectively corresponding to the audio channels from among the first speaker or the second speaker.

15. The method of claim 14, wherein the identifying the speakers respectively corresponding to the audio channels comprises:
based on identifying the first angle and the second angle included in the preset angle range, allocating, based on a direction of the video displayed in the flexible display, one audio channel among the audio channels for stereo to the first speaker; and
allocating another audio channel among the audio channels to the second speaker.

16. The method of claim 14, further comprising:
based on identifying the first angle included in the preset angle range and the second angle smaller than the preset angle range, refraining from controlling the second speaker using at least one of the audio channels.

17. The method of claim 16, wherein the refraining comprising:
displaying the video in a portion of the flexible display positioned on the first housing and the second housing from among portions of the flexible display distinguished by the second hinge assembly folded by an angle smaller than the preset angle range.

18. The method of claim 17, wherein the refraining comprises:
displaying, at a first portion of the flexible display in which the video is displayed, a visual object to move the video to a second portion of the flexible display distinguished by the second hinge assembly;
changing, in response to an input indicating to select the visual object, a location in the flexible display in which the video is displayed from the first portion to the second portion; and
controlling the second speaker by associating an audio channel among the audio channels that was outputted through the first speaker with the second speaker among the first speaker or the second speaker.

19. The method of claim 14, further comprising:
controlling, based on identifying the first angle and the second angle lower than the preset angle range, the first speaker and the second speaker using a volume lower than a preset volume.

20. The method of claim 14, further comprising:
in a state displaying a first video in the flexible display and displaying a second video in a cover display, displaying, based on identifying the first angle reduced to be lower than the preset angle range, the first video at a portion corresponding to the first housing among portions of the flexible display distinguished by the first hinge assembly folded by the first angle;
controlling the first speaker to output at least one of audio channels corresponding to the second video; and
controlling the second speaker to output at least one of audio channels corresponding to the first video.
